(19) United States
(12) Patent Application Publication
(10) Pub. No.: US 2025/0214214 A1
(43) Pub. Date: Jul. 3, 2025

(54) PREDICTIVE TORQUE CONTROL FOR A POWER TOOL

(71) Applicant: MILWAUKEE ELECTRIC TOOL CORPORATION, Brookfield, WI (US)

(72) Inventors: Kirat S. Mokha, Milwaukee, WI (US); Mitchell A. Ellena, West Allis, WI (US)

(21) Appl. No.: 19/003,037

(22) Filed: Dec. 27, 2024

Related U.S. Application Data
(60) Provisional application No. 63/616,170, filed on Dec. 29, 2023.

(51) Int. Cl. B25C 1/06

(52) U.S. Cl. CPC B25C 1/06

(57) ABSTRACT

A fastener driver includes a motor, a trigger, and a lifting assembly operable to be moved by the motor. The fastener driver includes a speed sensor, a voltage sensor, and a current sensor. A controller is configured to provide, in response to actuation of the trigger, power to the motor, receive speed signals from the speed sensor indicative of the speed of the motor, receive voltage signals from the voltage sensor indicative of the voltage of a battery pack, and receive current signals from the current sensor indicative of the current of the motor. The controller determines a torque of the motor based on the signals, determines whether the torque of the motor is less than or equal to a torque threshold, and activate an electronic clutch, in response to the torque of the motor being less than or equal to the torque threshold, to electronically brake the motor.

### RELATED APPLICATIONS

This application claims the benefit of U.S. Provisional Patent Application No. 63/616,170, filed Dec. 29, 2023, the entire content of which is hereby incorporated by reference.

### SUMMARY

Embodiments described herein provide systems and methods for implementing an electronic clutch in a powered fastener driver.

Fastener drivers including an electronic clutch described herein include a motor, a trigger, a battery pack interface configured to receive a battery pack, and a lifting assembly operable to be moved by the motor. The fastener driver includes a speed sensor configured to sense a speed of the motor, a voltage sensor configured to sense a voltage of the battery pack, and a current sensor configured to sense a current of the motor. The fastener driver includes a controller connected to the trigger, the motor, the speed sensor, the voltage sensor, and the current sensor. The controller is configured to provide, in response to actuation of the trigger and based on the position of the lifting assembly, power to the motor, receive speed signals from the speed sensor indicative of the speed of the motor, receive voltage signals from the voltage sensor indicative of the voltage of the battery pack, and receive current signals from the current sensor indicative of the current of the motor. The controller is configured to determine a torque of the motor based on the speed signals, the voltage signals, and the current signals, determine whether the torque of the motor is less than or equal to a torque threshold, and activate, in response to determining that the torque of the motor is less than or equal to the torque threshold, the electronic clutch to electronically brake the motor.

In some aspects, the controller is configured to activate the electronic clutch to electronically brake the motor for a first period of time, and provide, in response to the first period of time having passed, power to the motor.

In some aspects, the fastener driver further includes a position sensor configured to sense the position of the lifting assembly, and wherein the controller is further configured to receive position signals from the position sensor indicative of the position of the lifting assembly, where the torque of the motor is further determined based on the position of the lifting assembly.

In some aspects, the controller is further configured to set a position command used to drive the motor to a first position command when the lifting assembly is at a first position, set the position command to a second position command when the lifting assembly is at a second position, and set the position command to a third position command when the lifting assembly is at a third position.

In some aspects, the controller is further configured to compare the position command to the position of the lifting assembly sensed by the position sensor, and provide, in response to the position of the lifting assembly being less than the position command, power to the motor.

In some aspects, the controller is further configured to determine a torque limit based on the position of the lifting assembly, and control the motor based in part on the torque limit.

In some aspects, the controller is configured to detect a high load state of the motor based on the speed of the motor, and limit, in response to the high load state of the motor, a torque value at which to drive the motor.

In some aspects, the controller is further configured to determine, based on the speed of the motor and a speed command signal, a torque value at which to drive the motor, compare the torque value to a torque-velocity-current look-up table, determine, based on the comparison, a current value to provide to the motor, and provide the current value to the motor to drive the motor.

In some aspects, the controller is further configured to determine a pulse width modulation (PWM) duty cycle ratio based on the current of the motor and the current value, and drive the motor according to the PWM duty cycle ratio.

Methods for operating a fastener driving including an electronic clutch described herein include providing, in response to actuation of a trigger and based on the position of a lifting assembly, power to a motor, receiving speed signals from a speed sensor indicative of a speed of the motor, receiving voltage signals from a voltage sensor indicative of a voltage of a battery pack, and receiving current signals from a current sensor indicative of a current of the motor. The methods also include determining a torque of the motor based on the speed signals, the voltage signals, and the current signals, determining whether the torque of the motor is less than or equal to a torque threshold, and activating, in response to determining that the torque of the motor is less than or equal to the torque threshold, the electronic clutch to electronically brake the motor.

In some aspects, activating the electronic clutch includes activating the electronic clutch to electronically brake the motor for a first period of time, and wherein the method further includes providing, in response to the first period of time having passed, power to the motor.

In some aspects, the method further includes receiving position signals from a position sensor indicative of the position of the lifting assembly, where the torque of the motor is further determined based on the position of the lifting assembly.

In some aspects, the method further includes setting a position command used to drive the motor to a first position command when the lifting assembly is at a first position, setting the position command to a second position command when the lifting assembly is at a second position, and setting the position command to a third position command when the lifting assembly is at a third position.

In some aspects, the method further includes comparing the position command to the position of the lifting assembly sensed by the position sensor, and providing, in response to the position of the lifting assembly being less than the position command, power to the motor.

Fastener drivers including an electronic clutch described herein include a motor, a trigger, a battery pack interface configured to receive a battery pack, and a lifting assembly operable to be moved by the motor. The fastener driver includes a speed sensor configured to sense a speed of the motor, a voltage sensor configured to sense a voltage of the battery pack, and a current sensor configured to sense a current of the motor. The fastener driver includes a controller connected to the trigger, the motor, the speed sensor, the voltage sensor, and the current sensor. The controller is configured to provide, in response to actuation of the trigger and based on the position of the lifting assembly, power to the motor, receive speed signals from the speed sensor indicative of the speed of the motor, receive voltage signals from the voltage sensor indicative of the voltage of the battery pack, and receive current signals from the current sensor indicative of the current of the motor. The controller is configured to provide the speed signals, the voltage signals, and the current signals to a machine learning model, receive, from the machine learning model, an estimate of a torque of the motor, determine whether the torque of the motor is less than or equal to a torque threshold, and activate, in response to determining that the torque of the motor is less than or equal to the torque threshold, the electronic clutch to electronically brake the motor.

In some aspects, the controller is configured to activate the electronic clutch to electronically brake the motor for a first period of time, and provide, in response to the first period of time having passed, power to the motor.

In some aspects, the fastener driver further includes a position sensor configured to sense the position of the lifting assembly, and wherein the controller is further configured to receive position signals from the position sensor indicative of the position of the lifting assembly, where the torque of the motor is further determined based on the position of the lifting assembly.

In some aspects, controller is further configured to set a position command used to drive the motor to a first position command when the lifting assembly is at a first position, set the position command to a second position command when the lifting assembly is at a second position, and set the position command to a third position command when the lifting assembly is at a third position.

In some aspects, the controller is further configured to determine, based on the speed of the motor and a speed command signal, a torque value at which to drive the motor, compare the torque value to a torque-velocity-current look-up table, determine, based on the comparison, a current value to provide to the motor, and provide the current value to the motor to drive the motor.

In some aspects, the controller is further configured to determine a pulse width modulation (PWM) duty cycle ratio based on the current of the motor and the current value, and drive the motor according to the PWM duty cycle ratio.

Fastener drivers including an electronic clutch described herein include a motor, a trigger, a battery pack interface configured to receive a battery pack, and a lifting assembly operable to be moved by the motor. The fastener driver includes a sensor configured to sense a characteristic of the fastener driver. The fastener driver includes a controller connected to the trigger, the motor, and the sensor. The controller is configured to provide, in response to actuation of the trigger and based on the position of the lifting assembly, power to the motor, and receive a signal from the sensor indicative of the characteristic of the fastener driver. The controller is configured to determine a torque of the motor based on the signal from the sensor, determine whether the torque of the motor is less than or equal to a torque threshold, and activate, in response to determining that the torque of the motor is less than or equal to the torque threshold, the electronic clutch to electronically brake the motor.

Fastener drivers described herein include a motor, a trigger, a battery pack interface configured to receive a battery pack, a lifting assembly operable to be moved by the motor, a speed sensor configured to sense a speed of the motor, a voltage sensor configured to sense a voltage of the battery pack, a current sensor configured to sense a current of the motor, and a controller connected to the trigger, the motor, the speed sensor, the voltage sensor, and the current sensor. The controller is configured to provide, in response to actuation of the trigger and based on a position of the lifting assembly, power to the motor, receive speed signals from the speed sensor indicative of the speed of the motor, receive voltage signals from the voltage sensor indicative of the voltage of the battery pack, receive current signals from the current sensor indicative of the current of the motor, determine a torque of the motor based on the speed signals, the voltage signals, and the current signals, determine a condition of the fastener driver based on the torque of the motor, and provide an indication of the condition of the fastener driver.

In some aspects, the condition of the fastener driver includes a condition of the lifting assembly.

In some aspects, the fastener driver further includes a pressurized cylinder, and a bumper located at a bottom end of the cylinder, wherein the condition of the fastener driver includes a condition of the bumper.

In some aspects, the fastener driver further includes a pressurized cylinder, wherein the condition of the fastener driver includes a determination that a pressure of the cylinder is below a pressure threshold.

In some aspects, the condition of the fastener driver includes a jamming of the motor.

Methods described herein for determining a condition of a fastener driver include providing, in response to actuation of a trigger and based on a position of a lifting assembly, power to a motor, receiving speed signals from a speed sensor indicative of a speed of the motor, receiving voltage signals from a voltage sensor indicative of a voltage of a battery pack, receiving current signals from a current sensor indicative of a current of the motor, determining a torque of the motor based on the speed signals, the voltage signals, and the current signals, determining a condition of the fastener driver based on the torque of the motor, and providing an indication of the condition of the fastener driver.

In some aspects, the condition of the fastener driver includes a condition of the lifting assembly.

In some aspects, the condition of the fastener driver includes a condition of a bumper located at a bottom end of a cylinder.

In some aspects, determining the condition of the fastener driver includes determining that a pressure of a cylinder is below a pressure threshold.

In some aspects, the condition of the fastener driver includes a jamming of the motor.

Fastener drivers described herein include a motor, a trigger, a battery pack interface configured to receive a battery pack, a lifting assembly operable to be moved by the motor, a speed sensor configured to sense a speed of the motor, a voltage sensor configured to sense a voltage of the battery pack, a current sensor configured to sense a current of the motor, and a controller connected to the trigger, the motor, the speed sensor, the voltage sensor, and the current sensor. The controller is configured to provide, in response to actuation of the trigger and based on a position of the lifting assembly, power to the motor, receive speed signals from the speed sensor indicative of the speed of the motor, receive voltage signals from the voltage sensor indicative of the voltage of the battery pack, receive current signals from the current sensor indicative of the current of the motor, determine a torque of the motor based on the speed signals, the voltage signals, and the current signals, and alter a firing procedure of the fastener driver based on the torque of the motor.

In some aspects, to alter the firing procedure of the fastener driver, the controller is configured to adjust a ready-to-fire position of the lifting assembly based on the torque of the motor.

In some aspects, to alter the firing procedure of the fastener driver, the controller is configured to reduce a field weaking angle implemented by a field weakening module based on the torque of the motor.

In some aspects, to alter the firing procedure of the fastener driver, the controller is configured to limit a maximum value of a speed command used to drive the motor based on the torque of the motor.

In some aspects, the controller is further configured to drive, after altering the firing procedure of the fastener driver and in response to actuation of the trigger, the motor based on the altered firing procedure.

Methods of operating a fastener driver described herein include providing, in response to actuation of a trigger and based on a position of a lifting assembly, power to a motor, receiving speed signals from a speed sensor indicative of a speed of the motor, receiving voltage signals from a voltage sensor indicative of a voltage of a battery pack, receiving current signals from a current sensor indicative of a current of the motor, determining a torque of the motor based on the speed signals, the voltage signals, and the current signals, and altering a firing procedure of the fastener driver based on the torque of the motor.

In some aspects, altering the firing procedure of the fastener driver based on the torque of the motor includes adjusting a ready-to-fire position of the lifting assembly based on the torque of the motor.

In some aspects, altering the firing procedure of the fastener driver based on the torque of the motor includes reducing a field weakening angle implemented by a field weakening module based on the torque of the motor.

In some aspects, altering the firing procedure of the fastener driver based on the torque of the motor includes limiting a maximum value of a speed command used to drive the motor based on the torque of the motor.

In some aspects, the method includes driving, after altering the firing procedure of the fastener driver and in response to actuation of the trigger, the motor based on the altered firing procedure.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.]associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other features and aspects will become apparent by consideration of the following detailed description and accompanying drawings.

### BRIEF DESCRIPTION OF THE DRAWINGS

FIG. 1A illustrates a perspective view of a powered fastener driver.

FIG. 1B illustrates another perspective view of the powered fastener driver of FIG. 1A, with portions of a housing removed.

FIG. 1C illustrates a partial cross-sectional view of the powered fastener driver of FIG. 1A.

FIG. 2 illustrates a block diagram of a controller for the powered fastener driver of FIGS. 1A-1C in accordance with embodiments described herein.

FIG. 3 illustrates a block diagram of a control architecture implemented by the controller of FIG. 2 in accordance with embodiments described herein.

FIG. 4 illustrates a block diagram of a control block included in the control architecture of FIG. 3 in accordance with embodiments described herein.

FIG. 5 illustrates a block diagram of another control block included in the control architecture of FIG. 3 in accordance with embodiments described herein.

FIGS. 6A-6B illustrate graphs for measuring the absorption energy of a motor in accordance with embodiments described herein.

FIG. 7 illustrates a graph of a dynamic torque limiter in accordance with embodiments described herein.

FIG. 8 illustrates a block diagram of a method performed by the controller of FIG. 2 in accordance with embodiments described herein.

FIG. 9 illustrates a graph of actual and estimated torque values in accordance with embodiments described herein.

FIGS. 10A-10B illustrate unfiltered and filtered current signals in accordance with embodiments described herein.

FIGS. 11A-11B illustrate unfiltered and filtered position signals in accordance with embodiments described herein.

FIGS. 12A-12B illustrate estimated torque signals in accordance with embodiments described herein.

FIG. 13 illustrates a state machine block diagram for an electronic clutch in accordance with embodiments described herein.

FIG. 14 illustrates a block diagram of a speed controller in accordance with embodiments described herein.

FIG. 15 illustrates a block diagram of a look-up table operation in accordance with embodiments described herein.

FIG. 16 illustrates a block diagram of a bus current controller in accordance with embodiments described herein.

FIG. 17 illustrates a block diagram of another method performed by the controller of FIG. 2 in accordance with embodiments described herein.

FIGS. 18A-18B illustrate a block diagram of another method performed by the controller of FIG. 2 in accordance with embodiments described herein.

FIG. 19 illustrates a block diagram of another control block included in the control architecture of FIG. 3 in accordance with embodiments described herein.

FIG. 20 illustrates a block diagram of another method performed by the controller of FIG. 2 in accordance with embodiments described herein.

FIG. 21 illustrates a block diagram of another method performed by the controller of FIG. 2 in accordance with embodiments described herein.

FIG. 22 illustrates a partial cross-sectional view of the powered fastener driver of FIG. 1A including an initial striker-drop position and a modified striker-drop position in accordance with embodiments described herein.

FIG. 23 illustrates a graph showing the change in the striker drop position compared to an increasing number of operating cycles of the fastener driver of FIG. 1A in accordance with embodiments described herein.

FIG. 24 illustrates a graph showing the predicted peak torque compared to an increasing number of operating cycles of the fastener driver of FIG. 1A in accordance with embodiments described herein.

FIG. 25 illustrates a graph showing a ready-to-fire position and a top-dead-center position being adjusted based on the estimated torque of the motor in accordance with embodiments described herein.

FIG. 26 illustrates a graph showing a ready-to-fire position and a top-dead-center position being adjusted based on signals from a position sensor in accordance with embodiments described herein.

FIG. 27 illustrates a graph showing a rotational cycle of a lifter in accordance with embodiments described herein.

### DETAILED DESCRIPTION

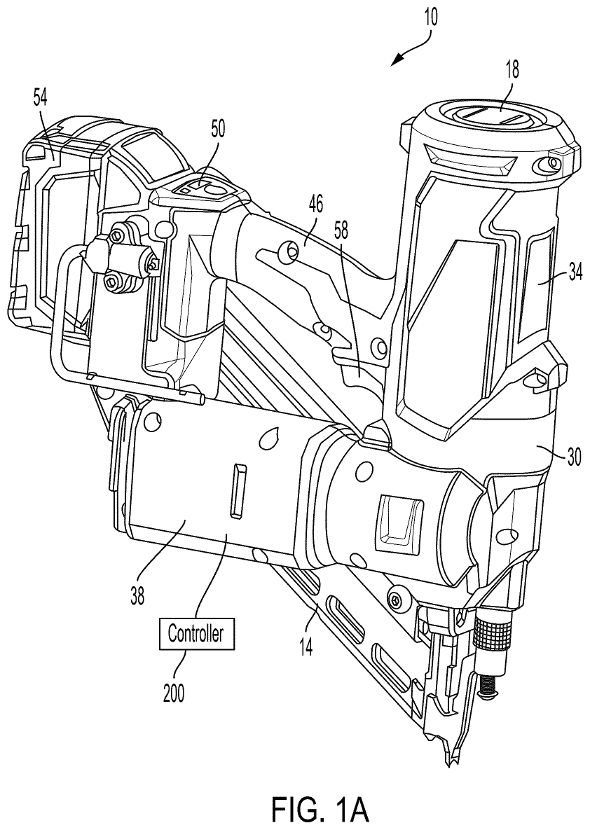

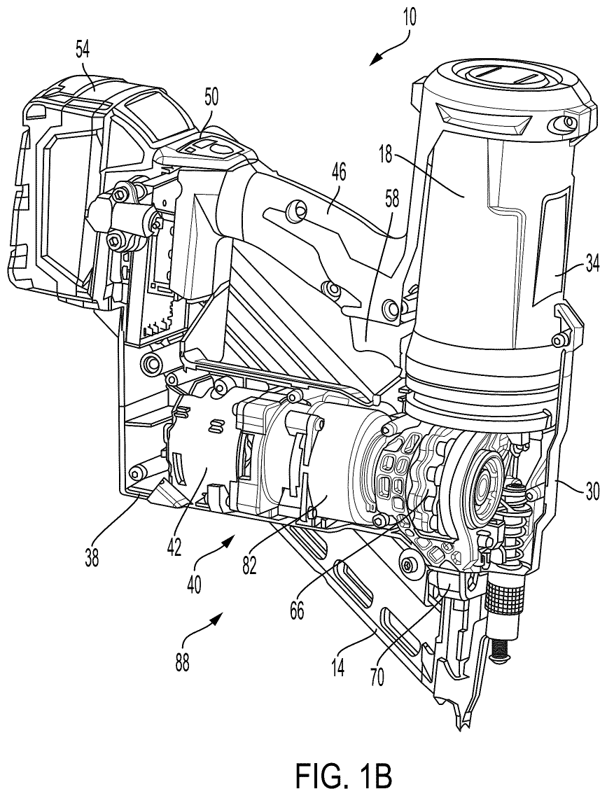

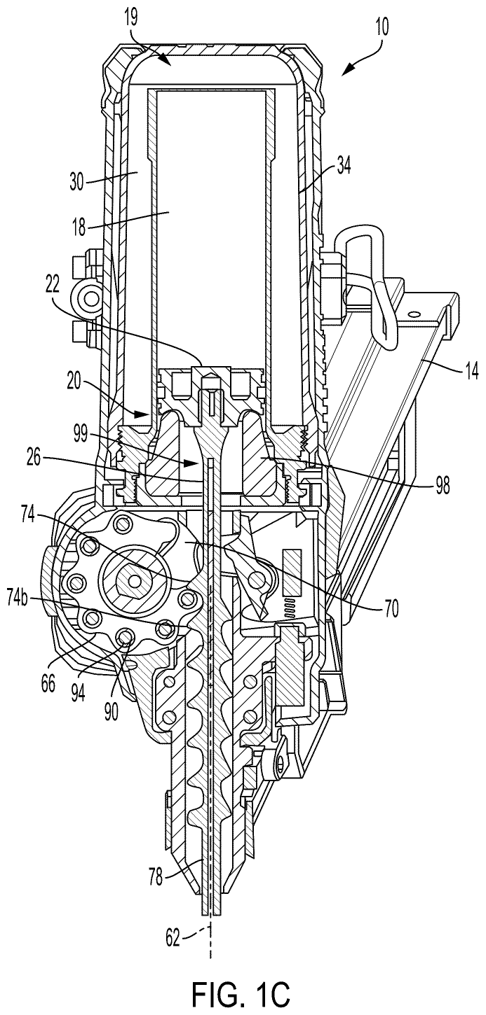

FIGS. 1A-1C illustrate a powered fastener driver 10 operable to drive fasteners (e.g., nails, tacks, staples, etc.) held within a magazine 14 into a workpiece. The fastener driver 10 includes an inner cylinder 18 with a moveable piston 22 positioned within the cylinder 18. The fastener driver 10 further includes a driver blade 26 that is attached to the piston 22 and moveable therewith.

The fastener driver 10 includes a housing 30 having a cylinder housing portion 34 and a motor housing portion 38 extending therefrom. The cylinder housing portion 34 is configured to support the cylinder 18, whereas the motor housing portion 38 is configured to support a drive unit 40. The drive unit 40 includes an electric motor 42 and a transmission 82 positioned downstream of the motor 42. In addition, the illustrated housing 30 includes a handle portion 46 extending from the cylinder housing portion 34, and a battery pack interface 50 coupled to an opposite end of the handle portion 46. A battery pack 54 is removably coupled to the battery pack interface 50 and supplies electrical power to the drive unit 40. The handle portion 46 supports a trigger 58, which is depressed by a user to initiate a driving cycle of the fastener driver 10.

With reference to FIG. 1C, the driver blade 26 defines a driving axis 62 and includes a plurality of driver blade teeth or lift teeth 74 formed along an edge 78 of the driver blade 26, which extends in the direction of the driving axis 62. In particular, the lift teeth 75 project laterally from the edge 78 relative to the driving axis 62. During a driving cycle, the driver blade 26 and piston 22 are moveable along the driving axis 62 between a top-dead-center (TDC) position and a bottom-dead-center (BDC) or driven position. The driver blade 26 may further be held in a ready position, which is positioned between the BDC position and the TDC position. The piston 22 is adjacent a top end 19 of the cylinder 18 in the TDC position, and the piston 22 is adjacent a bottom end 20 of the cylinder 18 in the BDC position. The fastener driver 10 further includes a rotary lifter 66 supported within the housing 30 by a frame 70. The rotary lifter 66 includes a plurality of rollers 90 supported by a plurality of pins 94. The lifter 66 is supported on a lifter frame 70 and receives torque from the drive unit 40, causing the lifter 66 to rotate. The lifter 66 and the drive unit 40 may be collectively referred to as a lifter assembly 88. As the lifter 66 rotates, the rollers 90 sequentially engage the lift teeth 74 formed on the driver blade 26 to return the driver blade 26 along the driving axis 62 from the BDC position toward the TDC position.

The cylinder 18 includes a bumper 98 located at the bottom end 20 of the cylinder 18. The bumper 98 has a generally annular, frustoconical shape with a central bore 99 therethrough. The bore 99 is coaxial with the driving axis 62 such that the driver blade 26 extends through the bore 99. As the piston 22 and the driver blade 26 move from the TDC position toward the BDC position, the piston 22 impacts the bumper 98, which absorbs the impact from the piston 22 and stops the piston 22 in the BDC position. In some embodiments, the bumper 98 is constructed of a resilient material (e.g., rubber, elastomeric material, or the like).

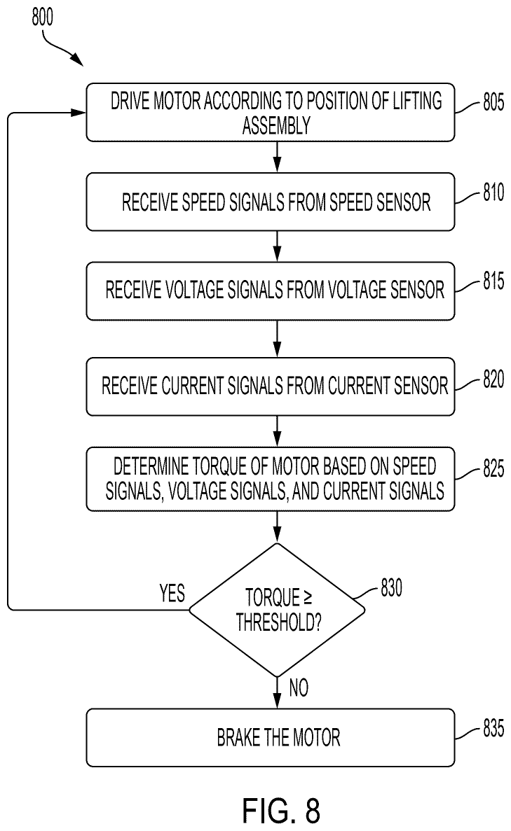

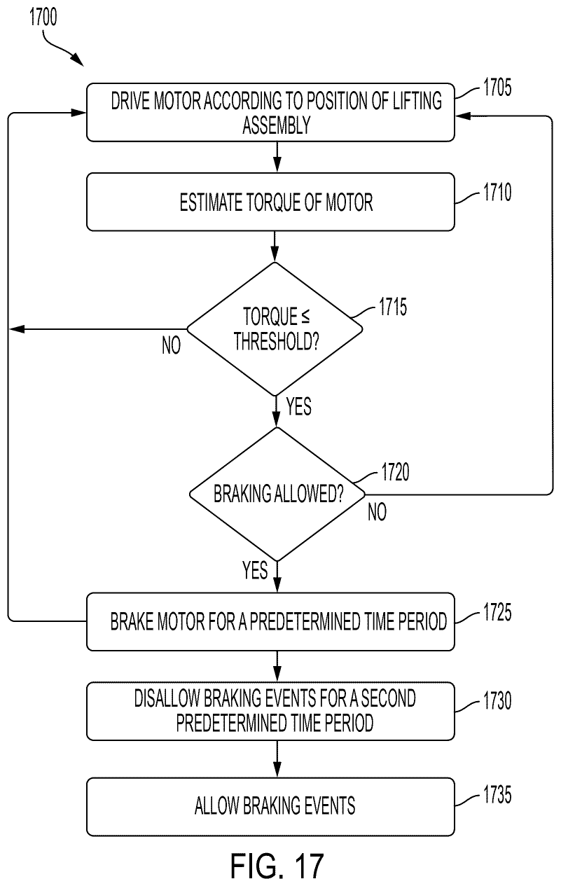

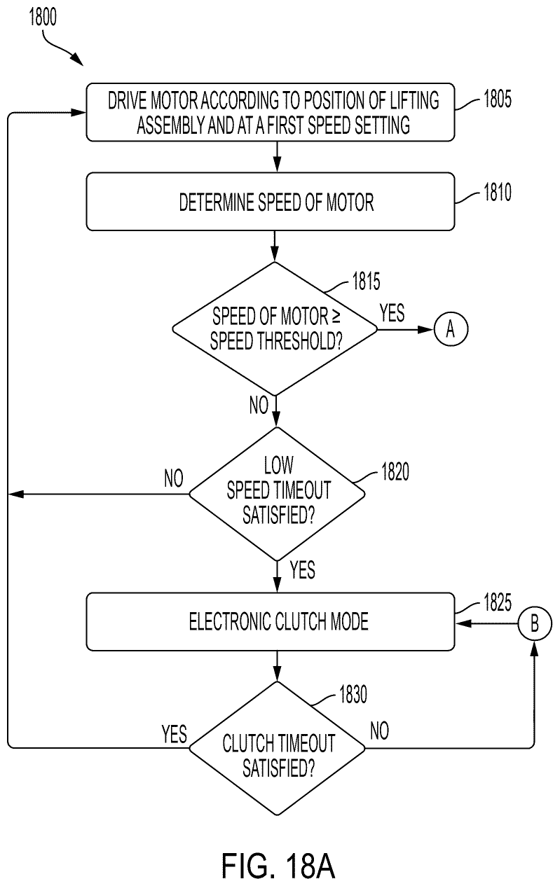

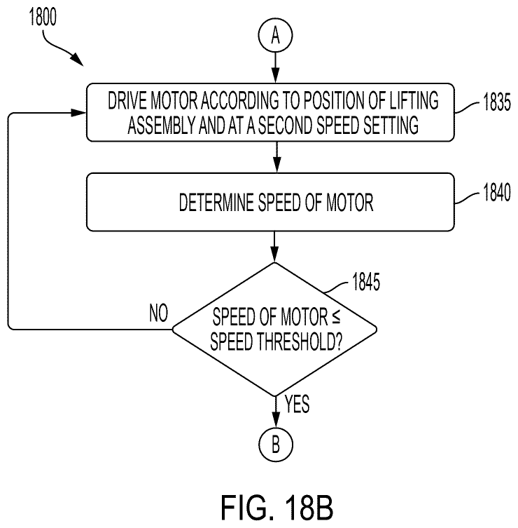

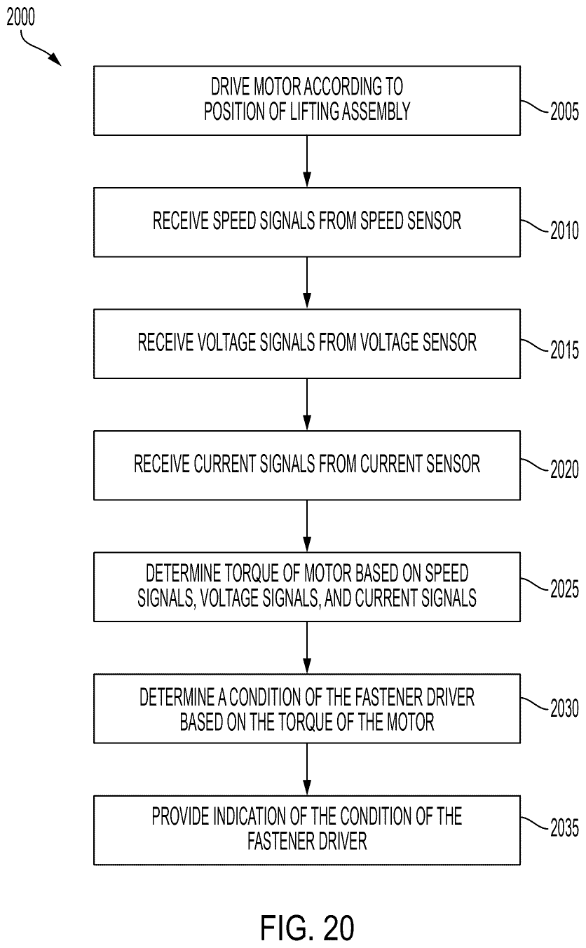

While examples described herein primarily relate to fastener drivers 10, methods and operations described herein (e.g., method 800 of FIG. 8, method 1700 of FIG. 17, method 1800 of FIGS. 18A-18B, method 2000 of FIG. 20, etc.) may also be implemented in other types of power tools, such as circular saws, chainsaws, screw guns (e.g., drywall screw guns), impact tools (e.g., impact drivers, impact wrenches, hammer drills, etc.), and the like.

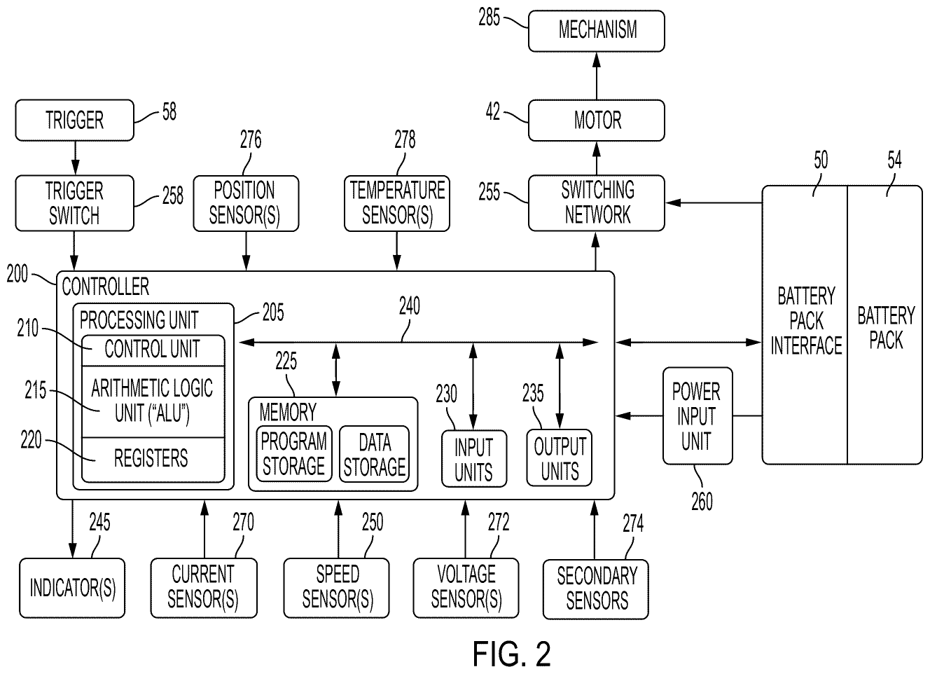

A controller 200 for the fastener driver 10 is illustrated in FIG. 2. The controller 200 is electrically and/or communicatively connected to a variety of modules or components of the fastener driver 10. For example, the illustrated controller 200 is connected to indicators 245, a current sensor 270, a speed sensor 250, a voltage sensor 272, secondary sensor(s) 274 (e.g., an accelerometer, a workpiece contact sensor, etc.), a position sensor 276, a temperature sensor 278, the trigger 58 (via a trigger switch 258), a power switching network 255, and a power input unit 260.

The controller 200 includes a plurality of electrical and electronic components that provide power, operational control, and protection to the components and modules within the controller 200 and/or fastener driver 10. For example, the controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALU”) 215, and a plurality of registers 220 (shown as a group of registers in FIG. 2), and is implemented using a known computer architecture (e.g., a modified Harvard architecture, a von Neumann architecture, etc.). The processing unit 205, the memory 225, the input units 230, and the output units 235, as well as the various modules connected to the controller 200 are connected by one or more control and/or data buses (e.g., common bus 240). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the fastener driver 10 can be stored in the memory 225 of the controller 200. The software includes, for example, firmware, one or more applications, program data, filters, rules, one or more program modules, and other executable instructions. The controller 200 is configured to retrieve from the memory 225 and execute, among other things, instructions related to the control processes and methods described herein. In other embodiments, the controller 200 includes additional, fewer, or different components.

The controller 200 drives the motor 42 to drive the piston 22 and the driver blade 26 in response to a user's actuation of the trigger 58. Depression of the trigger 58 actuates a trigger switch 258, which outputs a signal to the controller 200 to drive the motor 42, and therefore the piston 22 and the driver blade 26. In some embodiments, the controller 200 controls the power switching network 255 (e.g., a FET switching bridge) to drive the motor 42. For example, the power switching network 255 may include a plurality of high side switching elements (e.g., FETs) and a plurality of low side switching elements. The controller 200 may control each FET of the plurality of high side switching elements and the plurality of low side switching elements to drive each phase of the motor 42. For example, the power switching network 255 may be controlled to more quickly deaccelerate the motor 42. In some embodiments, the controller 200 monitors a rotation of the motor 42 (e.g., a rotational rate of the motor 42, a velocity of the motor 42, a position of the motor 42, and the like) via the speed sensor 250. The motor 42 may be configured to drive a mechanism 285 (e.g., the piston 22, the driver blade 26, a striker, etc.).

The indicators 245 are also connected to the controller 200 and receive control signals from the controller 200 to turn on and off or otherwise convey information based on different states of the fastener driver 10. The indicators 245 include, for example, one or more light-emitting diodes (LEDs), or a display screen. The indicators 245 can be configured to display conditions of, or information associated with, the fastener driver 10. For example, the indicators 245 can display information relating to an operational state of the fastener driver 10, such as a mode or speed setting. The indicators 245 may also display information relating to a fault condition, or other abnormality of the fastener driver 10. In addition to or in place of visual indicators, the indicators 245 may also include a speaker or a tactile feedback mechanism to convey information to a user through audible or tactile outputs. In some embodiments, the indicators 245 display information related to a braking operation or a clutch operation (e.g., an electronic clutch operation) of the controller 200. For example, one or more LEDs are activated when the controller 200 is performing a clutch operation.

The battery pack interface 50 is connected to the controller 200 and is configured to couple with a battery pack 54. The battery pack interface 50 includes a combination of mechanical (e.g., a battery pack receiving portion) and electrical components configured to and operable for interfacing (e.g., mechanically, electrically, and communicatively connecting) the fastener driver 10 with the battery pack 54. The battery pack interface 50 is coupled to the power input unit 260. The battery pack interface 50 transmits the power received from the battery pack 54 to the power input unit 260. The power input unit 260 includes active and/or passive components (e.g., voltage step-down controllers, voltage converters, rectifiers, filters, etc.) to regulate or control the power received through the battery pack interface 50 and to the controller 200. In some embodiments, the battery pack interface 50 is also coupled to the power switching network 255. The operation of the power switching network 255, as controlled by the controller 200, determines how power is supplied to the motor 42.

The current sensor 270 senses a current provided by the battery pack 54, a current associated with the motor 42, or a combination thereof. In some embodiments, the current sensor 270 senses at least one of the phase currents of the motor. The current sensor 270 may be, for example, an inline phase current sensor, a pulse-width-modulation-center-sampled inverter bus current sensor, or the like. The speed sensor 250 senses a speed of the motor 42. The speed sensor 250 may include, for example, one or more Hall effect sensors. The voltage sensor 272 senses a voltage provided by or associated with the battery pack 54. In some embodiments, the voltage sensor 272 senses other voltages within the fastener driver 10, such as a voltage of the motor 42. The position sensor 276 senses a position of the mechanism 285 (e.g., the piston 22, the driver blade 26, and/or the lifter assembly 88). The position sensor 276 may be an absolute position sensor, such as an optical or mechanical rotary encoder, a magnetic position sensor, a capacitive position sensor, an inductive sensor, or the like. The temperature sensor 278 senses a temperature associated with the fastener driver 10, such as a temperature of the motor 42, a temperature of the switching network 255, a temperature associated with the mechanism 285, and the like.

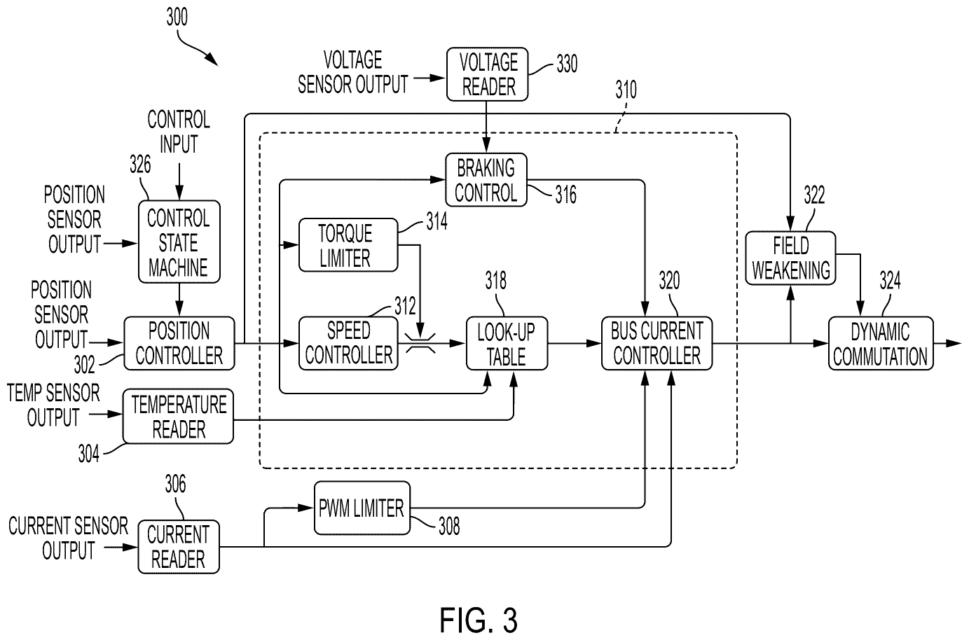

The controller 200 is configured to monitor operating characteristics of the fastener driver 10 to drive the motor 42. For example, FIG. 3 provides a block diagram of a control architecture 300 implemented by the controller 200. The control architecture 300 includes, among other things, a position controller 302, a temperature reader module 304, a current reader module 306, a pulse width modulation (PWM) limiter 308, a field weakening module 322, a dynamic commutation module 324, a control state machine 326, and a driving algorithm 310. The driving algorithm 310 includes, among other things, software and applications used to drive the motor 42, such as a speed controller 312, a torque limiter module 314, a braking control module 316, a look-up table 318, and a bus current controller 320. The control architecture 300 of FIG. 3 is merely an example. In other embodiments, functions of the various modules and controllers may be combined or separated into additional modules.

The control state machine 326 sets a position command based on the position of the mechanism 285 (as indicated by the position sensor 276) and based on a control input (e.g., actuation of the trigger 58, detection of the presence of a workpiece based on a signal from a workpiece contact sensor). For example, when the mechanism 285 reaches a ready-to-fire position (e.g., a first position) and the trigger 58 is actuated, the control state machine 326 sets the position command to a striker drop position command. When the mechanism 285 reaches the striker drop position (e.g., a second position), the control state machine 326 sets the position command to a striker re-mesh position command. The striker drop position may correspond to the BDC position. When the mechanism 285 reaches the striker re-mesh position (e.g., a third position), the control state machine 326 sets the position command to a ready to fire position command, completing the control cycle.

The position controller 302 receives the position command from the control state machine 326 and receives the position of the mechanism 285 from the position sensor 276. The position controller 302 compares the position command from the control state machine 326 to the actual position of the mechanism 285. If the actual position of the mechanism 285 is less than the commanded position, the position controller 302 outputs a positive speed command. If the actual position of the mechanism 285 is greater than or equal to the commanded position, the position controller 302 outputs a zero speed command. Accordingly, when the actual position of the mechanism 285 is at or exceeds the position command provided by the control state machine 326, the fastener driver 10 does nothing until the control state machine 326 catches up or a fault condition is corrected.

The temperature reader module 304 receives temperature signals from the temperature sensor 278 indicative of a temperature of the fastener driver 10. For example, the temperature reader module 304 receives temperature signals indicative of a temperature of the mechanism 285. In some embodiments, the temperature reader module 304 receives temperature signals indicative of a temperature of the motor 42 and/or the switching network 255. The temperature reader module 304 converts the temperature signal to a temperature value that is then provided to the driving algorithm 310. In some embodiments, the temperature signals from the temperature sensor 278 are provided directly to the driving algorithm 310. The temperature signals may be used by the driving algorithm 310 to improve torque repeatability over a wide temperature range.

The current reader module 306 receives current signals from the current sensor 270 indicative of the current of the motor 42. The current reader module 306 converts the received current signal to a current value (e.g., a voltage indicative of the current) that is then provided to the driving algorithm 310. In some embodiments, the current signals from the current sensor 270 are provided directly to the driving algorithm 310.

The PWM limiter 308 receives the current of the motor 42 from the current reader module 306. The PWM limiter 308 limits the maximum PWM ratio command used to drive the motor 42 to prevent low voltage conditions on the switching network 255 (e.g., gate drivers). The PWM ratio command limit is provided to the bus current controller 320.

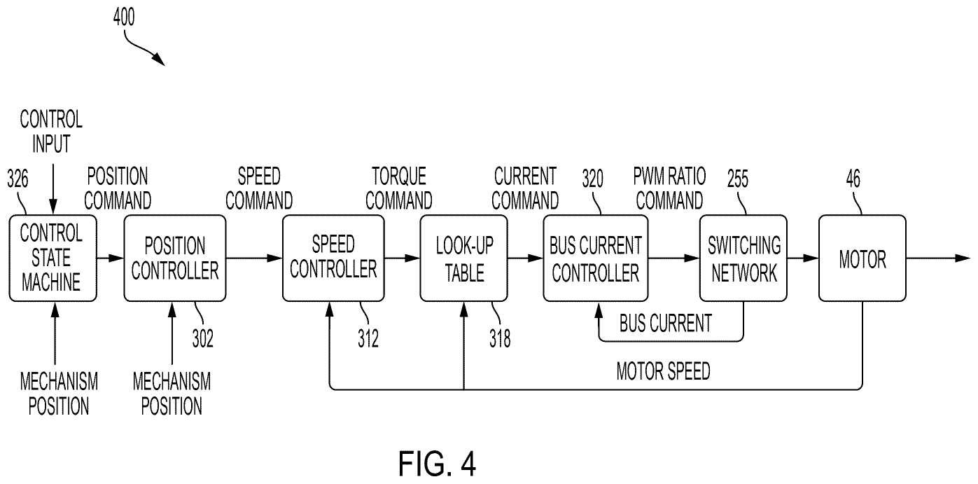

FIG. 4 provides a block diagram of a control block 400 for control of the motor 42. The control state machine 326 outputs a position command based on the position of mechanism 285 and a control input (e.g., actuation of the trigger 58, detection of the presence of a workpiece based on a signal from a workpiece contact sensor, etc.). The position controller 302 receives the position command from the control state machine 326 and compares the position command to the actual position of the mechanism 285. When the position of the mechanism 285 is less than the position indicated by the position command, the position controller 302 outputs a positive speed command. When the position of the mechanism 285 is greater than or equal to the position indicated by the position command, the position controller 302 outputs a zero speed command.

The speed controller 312 receives a speed command from the position controller 302. Additionally, the speed controller 312 receives a speed of the motor 42 (as indicated by speed sensor 250). The speed controller 312 compares the speed command provided by the position controller 302 with the detected speed of the motor 42 to determine a torque at which to drive the motor 42. For example, if the motor speed is less than the speed command, the speed controller 312 outputs a torque command (e.g., a torque value) to increase the speed of the motor 42. If the motor speed is greater than the speed command, the speed controller 312 outputs a torque command to decrease the speed of the motor 42. If the motor speed is equal to the speed command, the speed controller 312 outputs a torque command to maintain the speed of the motor 42.

The torque command and the motor speed are provided to the look-up table 318. The torque command and the motor speed are compared to the look-up table 318 to determine a current command, such as a current value or bus current value at which to drive the motor 42. The current command is provided to the bus current controller 320. The bus current controller 320 then compares the current command to the measured bus current (e.g., the measured current of the motor 42 as provided by the current reader module 306). The bus current controller 320 drives the switching network 255 with a PWM ratio command (e.g., a PWM duty cycle ratio command) based on this comparison. For example, if the current command is less than the measured bus current, the bus current controller 320 decreases the PWM duty cycle at which the switching network 255 is driven. If the current command is greater than the measured bus current, the bus current controller 320 increases the PWM duty cycle at which the switching network 255 is driven. If the current command is equal to the measured bus current, the bus current controller 320 maintains the PWM duty cycle at which the switching network 255 is driven.

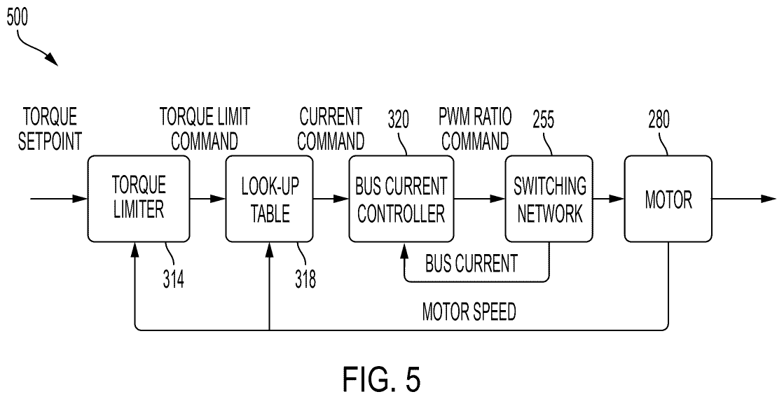

In some embodiments, the torque limiter module 314 limits the torque command provided by the speed controller 312. FIG. 5 provides a block diagram of a control block 500 for limiting the torque command. A torque setpoint is provided to the torque limiter module 314. The torque setpoint may be a predetermined value stored in the memory 225 to protect the mechanism 285 from an over-torque condition. In some embodiments, the torque setpoint is a function of the lifter position (e.g., position of the piston 22) that varies throughout the cycle of the fastener driver 10.

The torque limiter module 314 limits the torque based on, for example, an estimated absorption energy of the motor 42. The absorption energy is estimated based on the principle of balancing the mechanical flywheel energy of the motor 42 and the mechanism 285 with the available absorption energy of the components within the fastener driver 10. For example, the torque setpoint is selected to limit the stress on the various components of the fastener driver 10 in situations of a fastener jam (e.g., a nail jam) or misalignment of the mechanism 285.

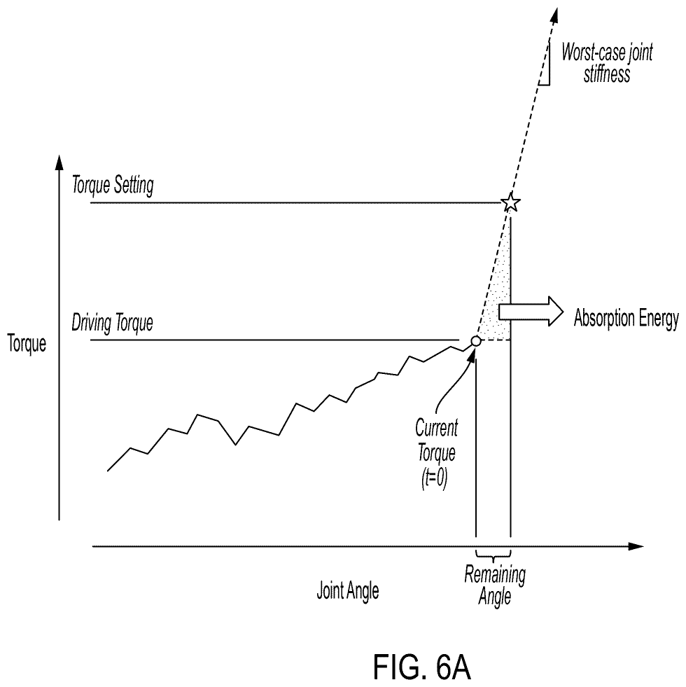

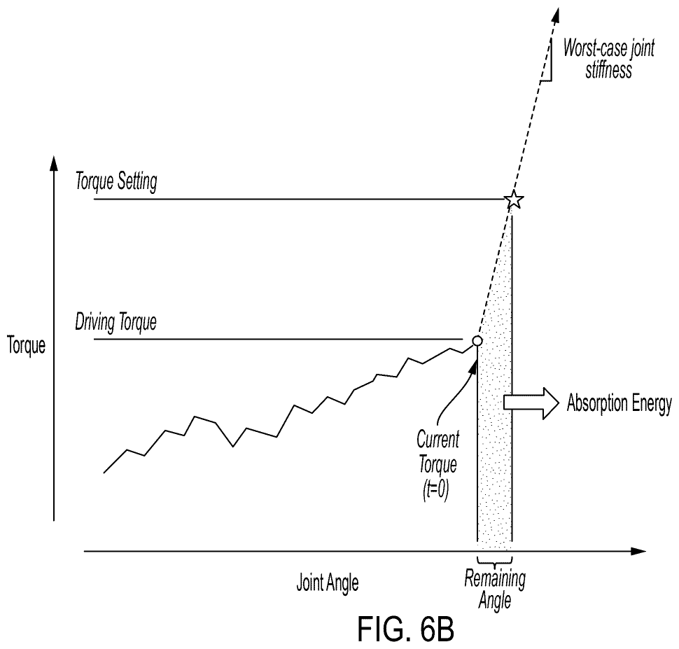

The absorption energy of the fastener is the integral of torque with respect to angle, and the net absorption energy of the fastener is the absorption energy minus the energy delivered by the torque of the motor 42. FIG. 6A provides an example of the absorption energy when the motor torque remains constant after joint. Equation 1 provides the absorption energy balanced with the flywheel energy:

½Jω²=(Tₛ−T_{d})²/2kⱼₒᵢₙₜ [Equation 1]
where:
J—fastener driver-reflected inertia from the perspective of the motor (kg-m²)
ω—motor velocity (rad/s)
Tₛ—torque setpoint (Nm)
T_{d}—driving torque (Nm)
kⱼₒᵢₙₜ—joint stiffness (Nm/rad)

When the torque limit is set to the driving torque, Equation 1 can be rearranged such that the torque limit is set based on the motor speed, the torque setpoint, driver fastener inertia, and joint stiffness, as shown in Equation 2:

Tₗᵢₘᵢₜ=T_{d}=Tₛ−\sqrt{Jkⱼₒᵢₙₜ}ω [Equation 2]
where:
Tₗᵢₘᵢₜ—torque limit (Nm)

In another example, all of the absorption energy of the piston 22 and the driver blade 26 is used to stop the motor 42. When the fastener is driven into a workpiece, the motor 42 returns the piston 22 and the driver blade 26 to its original position to reload for a new operation (e.g., moves the driver blade 26 and piston 22 from the BDC position to the TDC position). Accordingly, the motor 42 is de-energized the instant the fastener is secured (e.g., the driver blade 26 is in the BDC position), and negative torque is introduced in applying a brake. The absorption energy is absorbed back into the driver blade 26 and piston 22 (e.g., as binding energy). FIG. 6B provides an example of the absorption energy when the motor 42 is de-energized. Equation 3 provides the absorption energy balanced with the flywheel energy

$$\frac{1}{2} J {ω}^{2} = \frac{{T}_{s}^{2} - {T}_{d}^{2}}{2 {k}_{joint}} \qquad [ Equation 3 ]$$

When the torque limit is set to the driving torque, Equation 3 can be rearranged such that the torque limit is set based on the motor speed, the torque setpoint, drill inertia, and joint stiffness, as shown in Equation 4:

$${T}_{limit} = {T}_{d} = \sqrt{{T}_{s}^{2} - {Jk}_{joint} {ω}^{2}} \qquad [ Equation 4 ]$$

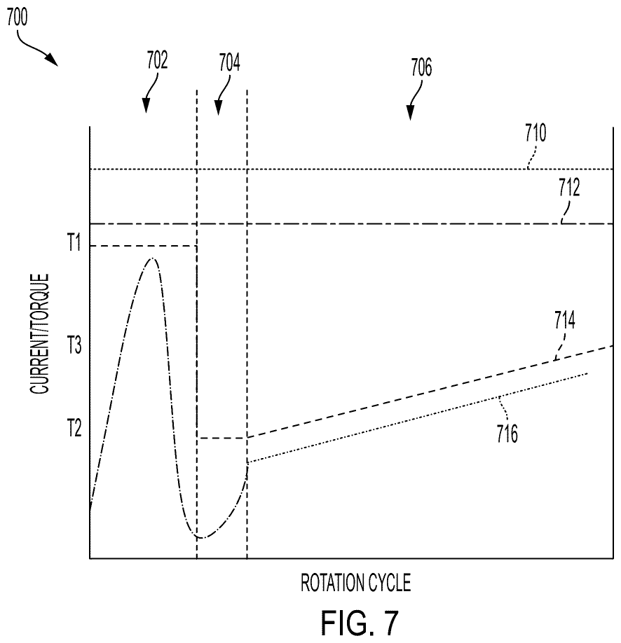

In another example, the torque limit is dynamic as a function of the system position. FIG. 7 provides a graph 700 illustrating the torque limit as a function of the position of the piston 22. The graph 700 includes a system limit torque 710, an e-clutch torque setting 712, a torque limit 714 set by the torque limiter module 314, and an operational torque 716 indicative of the torque as the fastener driver 10 operates (e.g., a motor current provided to the motor 42). Within a first region 702, the piston is fully compressed and the driver blade 26 drops to secure a fastener in the workpiece. At this point, the torque limit 714 is at its highest value T1.

Within the second region 704, lifter lugs within the lifter assembly 88 are re-meshed with striker teeth within the lifter assembly 88. At this point, the torque limit 714 is at its lowest value T2. The torque limit 714 in the second region 704 limits stresses applied by the lifter lugs and the striker teeth when they are not aligned, and the system experiences a binding event.

Within the third region 706, the piston 22 begins to compress partially to complete the reload cycle and prepare the fastener driver 10 to drive the next fastener. The torque limit 714 raises with the operational torque 716 to reload the piston 22 until the torque limit 714 reaches an intermediate or medium value T3.

Returning to FIG. 3, if the torque command is greater than the torque limit, the torque limit is instead provided to the look-up table 318. Control of the motor 42 is then continued using the torque limit as the torque command, as shown in FIG. 5.

In some embodiments, the PWM ratio command provided by the bus current controller 320 is overridden by the braking control module 316. The braking control module 316 monitors characteristics of the fastener driver 10 to determine whether to brake the motor 42. For example, the braking control module 316 receives a speed of the motor 42 (as indicated by speed sensor 250), a voltage of or associated with the battery pack 54 (as indicated by voltage sensor 272), and a current of the motor 42 (as indicated by current sensor 270). The braking control module 316 uses to the speed of the motor 42, the voltage of the battery pack 54, and the current of the motor 42 to estimate a torque of the motor 42. The estimated torque of the motor 42 is then compared to a threshold torque value to determine whether to brake the motor 42.

FIG. 8 provides a method 800 for controlling the motor 42. The method 800 may be performed by the controller 200. At block 805, the controller 200 drives the motor 42 according to the position of the lifting assembly 88. For example, the controller 200 drives the motor 42 according to the high speed mode while the trigger 58 is actuated and based on the position of the lifter assembly 88.

At block 810, the controller 200 receives speed signals from the speed sensor 250 indicative of the speed of the motor 42. At block 815, the controller 200 receives voltage signals from the voltage sensor 272 indicative of a voltage of the battery pack 54. At block 820, the controller 200 receives current signals from the current sensor 270 indicative of a current of the motor 42.

At block 825, the controller 200 determines a torque of the motor 42 based on the speed signals, the voltage signals, and the current signals. In one example, the controller 200 compares the speed of the motor 42, the voltage of the battery pack 54, and the current of the motor 42 to a look-up table (e.g., a speed-voltage-current-torque look-up table) to estimate the torque of the motor 42. In another example, the controller 200 provides the speed of the motor 42, the voltage of the battery pack 54, and the current of the motor 42 as inputs to an algorithm that estimates the torque of the motor 42. In one embodiment, the algorithm is a machine-learning model trained to estimate the torque of the motor 42. The machine learning model may be stored in the memory 225.

To implement the machine learning model, the controller 200 is configured to learn a general rule or model that maps the inputs to the outputs based on the provided example input-output pairs. The machine learning algorithm may be configured to perform machine learning using various types of methods. For example, the controller 200 may implement the machine learning program using decision tree learning (such as random decision forests), associates rule learning, artificial neural networks, recurrent artificial neural networks, long short term memory neural networks, inductive logic programming, support vector machines, clustering, Bayesian networks, reinforcement learning, representation learning, similarity and metric learning, sparse dictionary learning, genetic algorithms, k-nearest neighbor (KNN), among others, such as those listed in Table 1 below.

TABLE 1

| | |
|---|---|
| Recurrent | Recurrent Neural Networks [“RNNs”], Long Short-Term Memory |
| Models | [“LSTM”] models, Gated Recurrent Unit [“GRU”] models, Markov |
| | Processes, Reinforcement learning |
| Non-Recurrent | Deep Neural Network [“DNN”], Convolutional Neural Network [“CNN”], |
| Models | Support Vector Machines [“SVM”], Anomaly detection (ex: Principle |
| | Component Analysis [“PCA”]), logistic regression, decision trees/forests, |
| | ensemble methods (combining models), polynomial/Bayesian/other |
| | regressions, Stochastic Gradient Descent [“SGD”], Linear Discriminant |
| | Analysis [“LDA”], Quadratic Discriminant Analysis [“QDA”], Nearest |
| | neighbors classifications/regression, naïve Bayes, attention networks, |
| | transformer networks, etc. |

The controller 200 is programmed and trained to perform a particular task using the machine learning model. For example, in some embodiments, the controller 200 is trained to estimate an output torque of the fastener driver 10. The training examples used to train the machine learning algorithm may be graphs or tables of torque profiles. The training examples may be previously collected training examples, from, for example, a plurality of the same type of power tools. For example, the training examples may have been previously collected from a plurality of power tools of the same type (e.g., fastener driver 10) over a span of, for example, one year.

A plurality of different training examples is provided to the controller 200. The controller 200 uses these training examples to generate the machine learning model (e.g., a rule, a set of equations, and the like) that helps categorize or estimate the output based on new input data. The controller 200 may weight different training examples differently to, for example, prioritize different conditions or inputs and outputs to and from the controller 200. For example, certain observed operating characteristics may be weighed more heavily than others.

In one example, the controller 200 implements an artificial neural network. The artificial neural network includes an input layer, a plurality of hidden layers or nodes, and an output layer. Typically, the input layer includes as many nodes as inputs provided to the controller 200. The number (and the type) of inputs provided to the machine controller 200 may vary based on the particular task for the controller 200. Accordingly, the input layer of the artificial neural network of the controller 200 may have a different number of nodes based on the particular task for the controller 200. The input layer connects to the hidden layers. The number of hidden layers varies and may depend on the particular task for the controller 200. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input layer. These activation functions may vary and be based on not only the type of task associated with the controller 200, but may also vary based on the specific type of hidden layer implemented.

Each hidden layer may perform a different function. For example, some hidden layers can be convolutional hidden layers which can, in some instances, reduce the dimensionality of the inputs, while other hidden layers can perform statistical functions such as max pooling, which may reduce a group of inputs to the maximum value, an averaging layer, among others. In some of the hidden layers (also referred to as “dense layers”), each node is connected to each node of the next hidden layer. Some neural networks including more than, for example, three hidden layers may be considered deep neural networks. The last hidden layer is connected to the output layer. Similar to the input layer, the output layer typically has the same number of nodes as the possible outputs.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training algorithms can be used to adjust the bias values and the weights of the node connection based on the training examples. The training algorithms may include, for example, gradient descent, newton's method, conjugate gradient, quasi newton, and levenberg marquardt, among others.

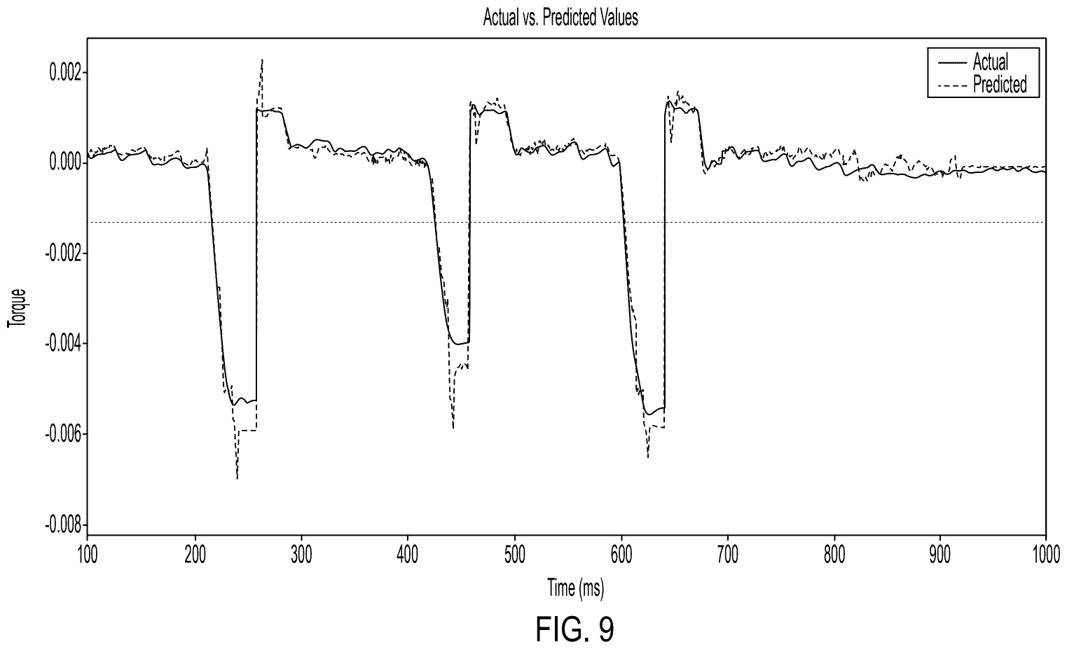

At block 830, the controller 200 determines whether the torque of the motor 42 is greater than or equal to a torque threshold. When the torque of the motor 42 is greater than or equal to the torque threshold (“YES” at block 830), the controller 200 returns to block 805 and continues driving the motor 42 according to the position of the lifter assembly 88. FIG. 9 illustrates a graph 900 of example estimated torque values compared to a torque threshold 905. As shown in the graph 900, estimating the torque of the motor 42 based on the speed of the motor 42, the voltage of the battery pack 54, and the current of the motor 42 results in approximately the same values as directly measuring the actual torque.

When the torque of the motor 42 is less than the torque threshold (“NO” at block 830), the controller 200 brakes the motor 42. In some instances, the controller 200 brakes the motor 42 by activating an electronic clutch, described below in more detail.

In some instances, the controller 200 also receives position signals from the position sensor 276 indicative of a position of the mechanism 285. The controller 200 also refers to the position signals to estimate the torque of the motor 42. For example, the position signals are also provided as an input to a machine learning model.

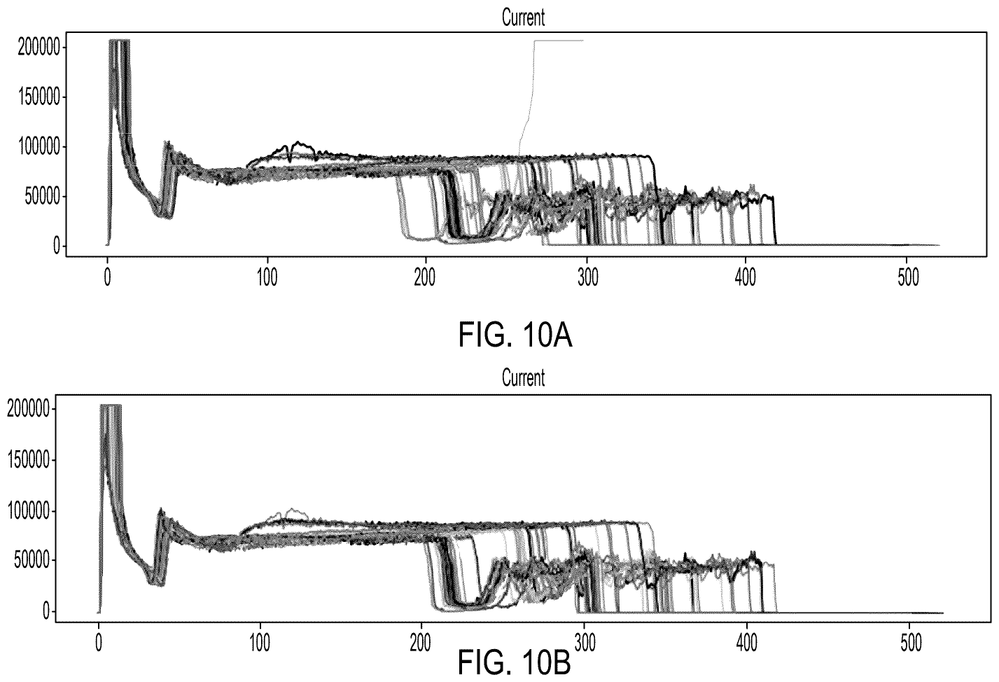

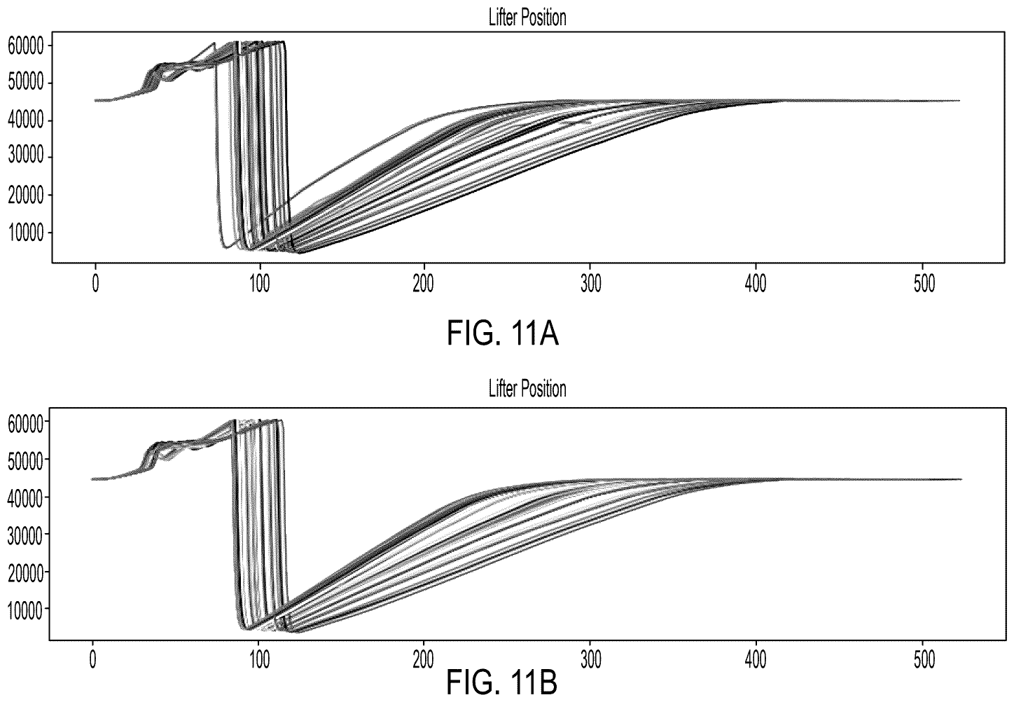

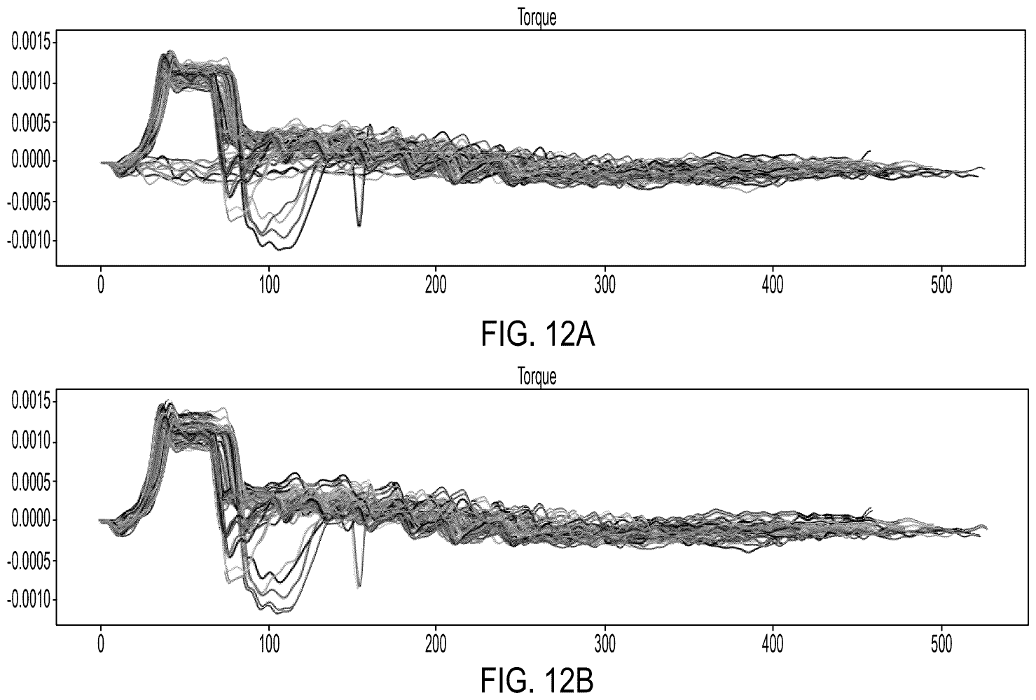

In some instances, the controller 200 filters the speed signal, the voltage signal, the current signal, and the position signal upon their receipt from the speed sensor 250, the voltage sensor 272, the current sensor 270, and the position sensor 276, respectively. For example, FIG. 10A illustrates example current signals from the current sensor 270, and FIG. 10B illustrates filtered current signals. FIG. 11A illustrates example position signals from the position sensor 276, and FIG. 11B illustrates filtered position signals. FIG. 12A illustrates an example torque determined with unfiltered signals, and FIG. 12B illustrates an example torque determined with filtered signals. Filtering may remove outlying signal values, such as current signals associated with a current in-rush event during initial driving of the motor 42, or position signals that shift up in value during a rollover event.

In some embodiments, rather than the torque of the motor 42, the controller 200 determines an estimate of another characteristic of the fastener driver 10. For example, the controller 200 determines a velocity of the lifter assembly 88, an acceleration of the lifter assembly 88, an acceleration of the motor 42, or a total power of the motor 42. Braking of the motor 42 is then controlled based on the estimated characteristic.

Additionally, in some instances, the controller 200 estimates the torque of the motor 42 based on a signal from a sensor or from multiple sensors. For example, a sensor senses a characteristic of the fastener driver 10. The controller 200 receives a signal from the sensor and estimates the torque of the motor 42 based on the characteristic of the fastener driver 10. The sensor may be the position sensor 276, the temperature sensor 278, the current sensor 270, the speed sensor 250, the voltage sensor 272, and/or a sensor included in the secondary sensors 274. Accordingly, rather than estimating the torque based on the speed signals, the voltage signals, and the current signals (as shown in the example of method 800), the torque may be estimated based on fewer or more characteristics of the fastener driver 10.

Accordingly, the braking control module 316 overrides the current command of the bus current controller 320 when the estimated torque of the motor 42 falls below (or, in some situations, equal to) a threshold.

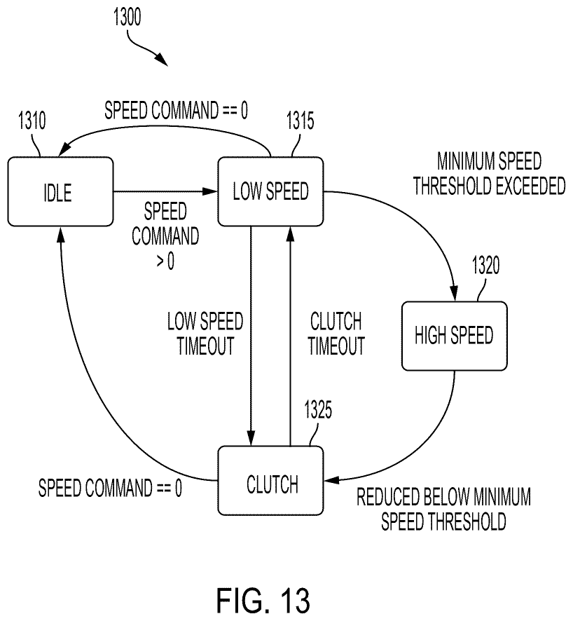

FIG. 13 provides a state diagram 1300 illustrating operation of the fastener driver 10, as performed by the controller 200. When the speed command of the motor 42 is set to 0 (e.g., when the trigger 58 is not actuated), the controller 200 is in an idle mode (block 1310). When in the idle mode, the controller 200 monitors for actuation of the trigger 58, and the switching network 255 is placed in a high impedance state to prevent power transfer from the battery pack 54 to the motor 42. When the trigger 58 is actuated (e.g., when the speed command is greater than 0), the controller 200 proceeds to block 1315 and operates the motor 42 according to a low speed mode (e.g., a first operating mode, a first speed setting, etc.). The low speed mode may be, for example, an operating mode associated with beginning of driving the motor 42 when the motor 42 was fully stopped. While in the low-speed mode, the controller 200 monitors the speed of the motor 42 as provided by the speed sensor 250. In some embodiments, while in the low-speed mode, the speed controller 312 is bypassed, and the motor 42 is controlled such that the torque output of the speed controller 312 is equal to the torque setpoint. If the speed of the motor 42 increases above or equal to a minimum speed threshold, the controller 200 proceeds to block 1320. In some embodiments, the minimum speed threshold has a value of between 500 rotations per minute (“RPM”) and 3000 RPM. In some embodiments, the minimum speed threshold has a value of approximately 1800 RPM. However, if the speed of the motor 42 remains below the minimum speed threshold for a low speed timeout period (e.g., a first predetermined time period), the controller 200 instead proceeds to block 1325. If the speed command is set to zero (o) at any point (e.g., the trigger 58 is de-actuated), the controller 200 transitions back to the idle mode (block 1310).

When the speed of the motor 42 exceeds or is equal to the minimum speed threshold, the controller 200 proceeds to block 1320 and operates in a high speed mode (e.g., a second operating mode, a second speed setting). While in the high speed mode, the controller 200 drives the motor 42 according to received speed commands while within the set torque limits. The speed controller 312 is active, and the torque limiter module 314 may limit the torque output of the speed controller 312, which may reduce speed for clutch settings or when a significant load is applied. For example, when a high load state is detected based on the speed of the motor 42, the torque output of the speed controller 312 is limited.

When the speed of the motor 42 drops below the minimum speed threshold while operating in the high speed mode, the controller 200 proceeds to block 1325 and operates in a clutch mode. In some embodiments, hysteresis can be used such that different speed thresholds are used to control transitions from the low speed mode and high speed mode. Additionally, when the controller 200 operates in the low speed mode (block 1315) for a predetermined time period, the controller 200 proceeds to block 1325 and operates in the clutch mode. While in the clutch mode, the controller 200 limits the current of the motor 42. For example, the current command provided to the bus current controller 320 by the look-up table 318 is overwritten by a low current command. In some embodiments, the low current command corresponds to a current value low enough to maintain engagement of the motor 42 with a related geartrain, but does not overcome geartrain friction. This results in a zero torque value of the lifter assembly 88. The low current command is maintained for a clutch timeout period, at which point the controller 200 returns to block 1315 and operates in the low speed mode. If the trigger 58 is de-actuated while the controller 200 is in the clutch mode, the controller 200 returns to block 1310 and operates in the idle mode. Additionally, in some instances, due to the clutch timeout period and the low speed timeout period, the controller 200 may alternate between the low speed mode at block 1315 and the clutch mode at block 1325 indefinitely until the trigger 58 is de-actuated. In some instances, the current of the motor 42 is limited by reducing the duty cycle of the PWM used to drive the motor 42. In some embodiments, the clutch timeout period and the low speed timeout period have values between 5 milli-seconds and 100 milli-seconds. In some embodiments, the clutch timeout period and the low speed timeout period have values of approximately 15 milli-seconds.

In some embodiments, the controller 200 operates in the clutch mode when the estimated torque of the motor 42 drops below a minimum torque threshold, as described with respect to FIG. 8. Accordingly, due to the clutch timeout period, if the torque does not recover and go above the torque threshold, the controller 200 may alternate between the low speed mode at block 1315 and the clutch mode at block 1325 indefinitely until the trigger 58 is de-actuated.

Returning to FIG. 3, the field weakening module 322 is configured to improve torque capability at high speeds when the back-electromotive force (“EMF”) of the motor 42 causes the drive to become voltage limited. Field weakening may be applied by identifying the relationship between motor current, motor torque, and motor speed at a steady state. This relationship may be used to correct nominal field weakening. In some embodiments, the field weakening module 322 is disabled.

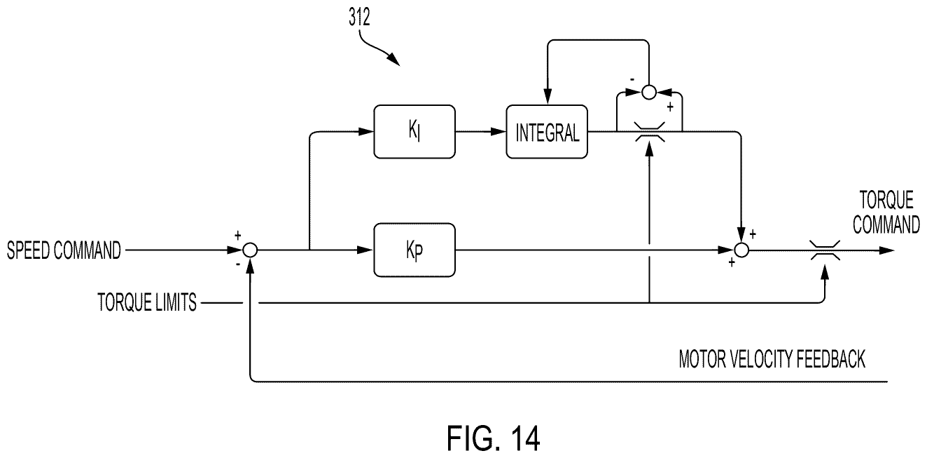

FIG. 14 illustrates an example block diagram of the speed controller 312. Equation 5 provides an example model for determining a torque command based on the motor speed:

$${T}_{C} + b ω + J \frac{d ω}{dt} = {T}_{drive} \qquad [ Equation 5 ]$$

Equation 6 provides a simplified transfer function of the model of Equation 5:

$$\frac{Ω ( s )}{{T}_{drive} ( s )} = \frac{1}{Js + b} \qquad [ Equation 6 ]$$

The torque command output by the speed controller 312 is locked to the upper torque limit any time the controller 200 is operating in the low speed mode. When the controller 200 is in the clutch mode, the torque command is overwritten downstream. However, the speed controller 312 continues operation. The illustrated speed controller 312 includes two gains: a proportional gain K_{P} and an integral gain K_{I}.

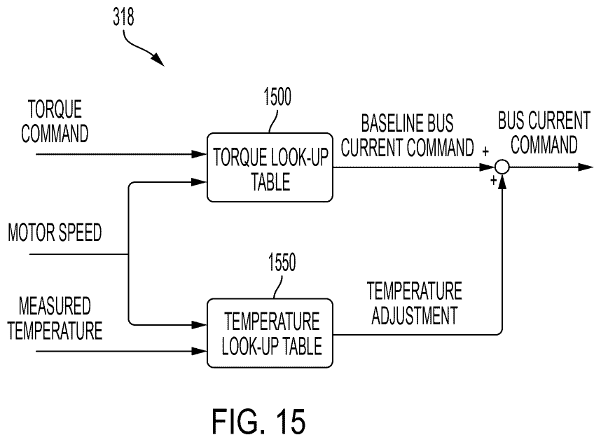

FIG. 15 illustrates an example block diagram of the look-up table 318. The torque command from the speed controller 312 is compared to the motor speed at a torque look-up table 1500. The torque look-up table 1500 (e.g., a torque-velocity-current look-up table) outputs a baseline bus current command. Additionally, the motor speed is compared to the measured temperature, as provided by the temperature reader module 304, at a temperature look-up table 1550. The output of the temperature look-up table 1550 is a temperature adjustment output. The temperature adjustment output is applied to the baseline bus current command to create the bus current command provided to the bus current controller 320.

In some embodiments, rather than using the look-up table 318, the torque command is converted to the bus current command using a slope-intercept method. The slope-intercept method converts torque to current independent of the motor speed and the temperature. For a given gear ratio, a slope and an intercept are provided to convert the torque to a current command.

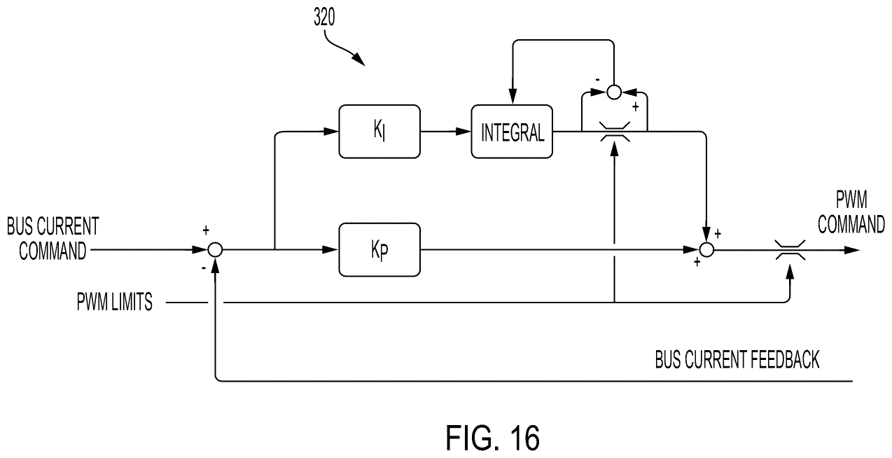

FIG. 16 illustrates an example block diagram of the bus current controller 320. The bus current controller 320 outputs a PWM ratio command signal based on the bus current command from the look-up table 318. Equation 7 provides an example model for determining a PWM ratio command signal based on the bus current:

$${R}_{eq} {i}_{batt} + {L}_{eq} \frac{{di}_{batt}}{dt} + {K}_{e} ω = {V}_{batt} {d}_{PWM} \qquad [ Equation 7 ]$$

If velocity is constant relative to the electrodynamics and the battery voltage is constant, the model of Equation 7 becomes a transfer function defined by Equation 8:

$$\frac{{I}_{batt} ( s )}{{d}_{PWM} ( s )} = {V}_{batt} \frac{1}{{L}_{eq} s + {R}_{eq}} \qquad [ Equation 8 ]$$

When the controller 200 is operating in the low speed mode or the high speed mode, the bus current controller 320 operates normally. When in the idle mode or when braking, the PWM ratio command output is overridden to zero. When in the clutch mode, the bus current command is overridden to another value to overcome cogging torque and reduce system backlash. Additionally, in some embodiments, when transitioning from the clutch mode to the low speed mode, the PWM ratio command is overwritten to a value that increases jerk of the fastener driver 10. Additionally, the bus current controller 320 may limit the PWM ratio command output to prevent bus current overshoot (e.g., an overcurrent condition). The illustrated current controller 320 includes two gains: a proportional gain K_{P} and an integral gain K_{I}.

FIG. 17 illustrates a method 1700 for controlling the motor 42. The method 1700 may be performed by the controller 200. At block 1705, the controller 200 drives the motor 42 according to the position of the mechanism 285. For example, the controller 200 drives the motor 42 according to the high speed mode while the trigger 58 is actuated and based on the position of the lifter assembly 88. At block 1710, the controller 200 estimates the torque of the motor 42, as previously described with respect to the method 800.

At block 1715, the controller 200 determines whether the torque of the motor 42 is less than or equal to a torque threshold. If the estimated torque of the motor 42 is greater than the torque threshold (“NO” at block 1715), the controller 200 returns to block 1705 and continues to drive the motor 42 according to the position of the lifter assembly 88. If the estimated torque of the motor 42 is less than or equal to the torque threshold (“YES” at block 1715), the controller 200 proceeds to block 1720.

At block 1720, the controller 200 determines whether braking of the motor 42 is allowed. For example, to prevent false braking triggers, braking of the motor 42 may be disallowed for a predetermined period of time after a braking event is completed, as braking causes deceleration of the motor that may result in a reduction of torque that satisfies the torque threshold a second time. By disallowing recurrent braking events, the controller 200 avoids false braking events. If braking events are not allowed, the controller 200 returns to block 1705 and continues to drive the motor 42 according to the position of the lifter assembly 88. If braking events are allowed, the controller proceeds to block 1725. In some embodiments, braking events are not disallowed, and block 1720 (and blocks 1730 and 1735) may be removed from the method 1700.

At block 1725, the controller 200 brakes the motor 42 for a predetermined time period. For example, the controller 200 controls the switching network 255 to electronically brake the motor 42. Once the predetermined period of time is satisfied, the controller 200 disallows braking events (at block 1730) and returns to block 1705. The controller 200 disallows braking events for a second predetermined time period to prevent false braking triggers. Once the second predetermined time period is satisfied, the controller 200 allows braking events to be performed (at block 1735). In some embodiments, braking is disabled at low speeds (e.g., 2000 RPM or fewer) or low torque values.

FIGS. 18A-18B illustrate a method 1800 for controlling the motor 42. The method 1800 may be performed by the controller 200. The method 1800 may be performed in parallel to the method 1700 of FIG. 17. At block 1805, the controller 200 drives the motor 42 according to the position of the lifter assembly 88 and at a first speed setting. For example, the controller 200 drives the motor 42 according to the low speed mode while receiving a speed command from the trigger 58 and based on the position of the lifter assembly 88. At block 1810, the controller 200 determines the speed of the motor 42. For example, in some embodiments, the controller 200 receives speed signals from the speed sensor 250 indicative of the speed of the motor 42. In other embodiments, the controller 200 determines the speed of the motor 42 based on current signals from the current sensor 270.

At block 1815, the controller 200 determines whether the speed of the motor 42 is greater than or equal to a speed threshold. If the speed of the motor 42 is greater than or equal to the speed threshold, the controller 200 proceeds to block 1835 (see FIG. 18B). If the speed of the motor 42 is less than the speed threshold, the controller 200 determines whether the low speed timeout threshold has been satisfied (block 1820). If the low speed timeout threshold is not satisfied, the controller 200 returns to block 1805 and continues to drive the motor 42 according to the position of the lifter assembly 88.

If the low speed timeout threshold is satisfied, the controller 200 proceeds to block 1825 and enters the electronic clutch mode. In the electronic clutch mode, the controller 200 drives the motor 42 according to a low current command (e.g., reduced PWM duty cycle), as previously described. At block 1830, the controller 200 determines whether the clutch timeout period is satisfied. If the clutch timeout period is satisfied, the controller 200 returns to block 1805 and drives the motor 42 according to the first speed setting. If the clutch timeout period is not satisfied, the controller 200 returns to block 1825 and continues to operate in the electronic clutch mode. In some embodiments, the clutch timeout period corresponds to between 10 and 100 milli-seconds. In some embodiments, the clutch timeout period is approximately 35 milli-seconds.

Returning to block 1815, if the speed of the motor is greater than or equal to the speed threshold, the controller 200 proceeds to block 1835. At block 1835, the controller 200 drives the motor 42 according to the position of the lifter assembly 88 and at a second speed setting. In some embodiments, the second speed setting is the high speed mode. At block 1840, the controller 200 determines the speed of the motor 42. For example, in some embodiments, the controller 200 receives speed signals from the speed sensor 250 indicative of the speed of the motor 42. In other embodiments, the controller 200 determines the speed of the motor 42 based on current signals from the current sensor 270.

At block 1845, the controller 200 determines whether the speed of the motor 42 is less than or equal to the speed threshold. If the speed of the motor 42 is greater than the speed threshold, the controller 200 continues to drive the motor 42 according to the position of the lifter assembly 88 and at the second speed setting. If the speed of the motor 42 is less than or equal to the speed threshold, the controller 200 proceeds to block 1825 and enters the electronic clutch mode. For example, the method 1700 in FIG. 17 can cause a rapid slowdown of the motor 42 that causes the motor speed to become less than the speed threshold and the transition from the second speed setting to the electronic clutch mode.

To avoid distributed stopping positions throughout an operating cycle of the fastener driver 10, embodiments described herein provide for alternative stopping point biasing and dynamic error margins for control of the motor 42. For example, embodiments described herein may bias the stopping point of the motor 42 closer to the striker drop position, reducing time between the trigger pull and driving of a fastener. Additionally, the tolerance window may have a lower bound to avoid a double fire event (e.g., from about 30 degrees to about 5 degrees).

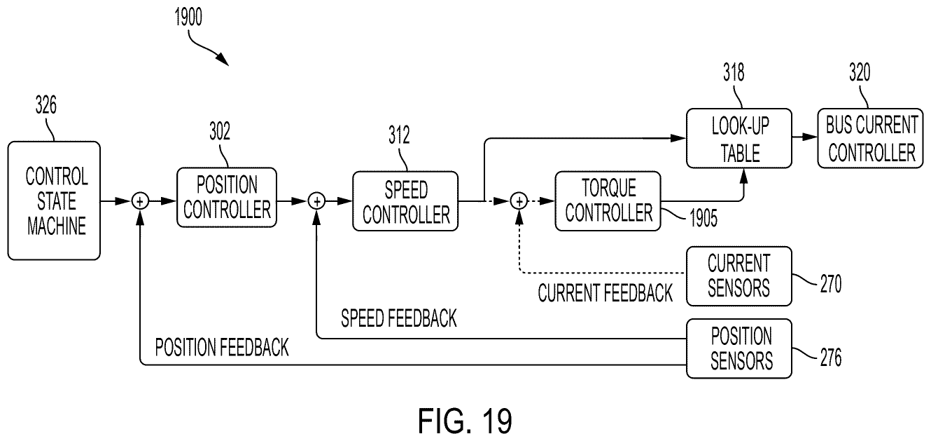

FIG. 19 provides a block diagram of a control block 1900 for position control of the motor 42. The control state machine 326 outputs a position command based on the position of mechanism 285 (indicated by position feedback from the position sensors 276) and a control input (e.g., actuation of the trigger 58, detection of the presence of a workpiece based on a signal from a workpiece contact sensor, etc.).

The speed controller receives the speed command from the position controller 302. Additionally, the speed controller 312 receives a speed of the motor 42. In the example of FIG. 19, the speed controller 312 determines the speed of the motor 42 based on position signals received from the position sensors 276, for example, by determining a derivative of the position signals. However, in other instances, the speed controller 312 may receive the speed of the motor 42 as indicated by speed sensor 250. The speed controller 312 compares the speed command provided by the position controller 302 with the detected speed of the motor 42 to determine a torque at which to drive the motor 42. For example, if the motor speed is less than the speed command, the speed controller 312 outputs a torque command to increase the speed of the motor 42. If the motor speed is greater than the speed command, the speed controller 312 outputs a torque command to decrease the speed of the motor 42. If the motor speed is equal to the speed command, the speed controller 312 outputs a torque command to maintain the speed of the motor 42.

In some instances, the torque command is provided to look-up table 318 to determine a current command for bus current controller 320, as previously described. In other instances, however, the control block 1900 includes a torque controller 1905. The torque controller 1905 receives the torque command from the speed controller 312 and a motor current of the motor 42 (indicated by the current sensors 270). In some embodiments, the torque controller 1905 determines a present torque of the motor 42 based on the motor current of the motor 42. The torque controller 1905 compares the torque command provided by the speed controller 312 with the detected torque of the motor 42 to determine whether to adjust the torque command provided to the look-up table 318. For example, if the motor torque is less than the torque command, the torque controller 1905 adjusts the torque command to increase the torque of the motor 42. If the motor torque is greater than the torque command, the torque controller 1905 adjusts the torque command to decrease the torque of the motor 42. If the motor torque is equal to the torque command, the torque controller 1905 maintains the value of the torque command provided by the speed controller 312.

In some instances, the controller 200 tracks the performance of the fastener driver 10. For example, the controller 200 may track a type of the battery pack 54 received by the fastener driver 10. The controller 200 may track whether the lifter assembly 88 jams during operation of the fastener driver 10 and a position at which the lifter assembly 88 jammed. These events may be logged in a report, may be used for training of the machine learning model, and the like.

In some instances, the controller 200 monitors the condition of the fastener driver 10 based on the torque of the motor 42. FIG. 20 provides a method 2000 for controlling the motor 42. The method 2000 may be performed by the controller 200. At block 2005, the controller 200 drives the motor 42 according to the position of the lifting assembly 88. For example, the controller 200 drives the motor 42 according to the high speed mode while the trigger 58 is actuated and based on the position of the lifter assembly 88.

At block 2010, the controller 200 receives speed signals from the speed sensor 250 indicative of the speed of the motor 42. At block 2015, the controller 200 receives voltage signals from the voltage sensor 272 indicative of a voltage of the battery pack 54. At block 2020, the controller 200 receives current signals from the current sensor 270 indicative of a current of the motor 42.

At block 2025, the controller 200 determines a torque of the motor 42 based on the speed signals, the voltage signals, and the current signals. In one example, the controller 200 compares the speed of the motor 42, the voltage of the battery pack 54, and the current of the motor 42 to a look-up table (e.g., a speed-voltage-current-torque look-up table) to estimate the torque of the motor 42. In another example, the controller 200 provides the speed of the motor 42, the voltage of the battery pack 54, and the current of the motor 42 as inputs to an algorithm that estimates the torque of the motor 42. In one embodiment, the algorithm is a machine-learning model trained to estimate the torque of the motor 42, as previously described with respect to block 825 of FIG. 8. The machine learning model may be stored in the memory 225.

At block 2030, the controller 200 determines a condition of the fastener driver 10 based on the torque of the motor 42. For example, an expected torque value of the motor 42 increases over the life of the fastener driver 10. As the fastener driver 10 experiences an increasing number of operations, the torque of the motor 42 also naturally increases. This increase in torque may be due to wear and degradation of components of the fastener driver 10. In some implementations, the controller 200 compares the torque of the motor 42 to a threshold. When the torque of the motor 42 is greater than or equal to the threshold, the controller 200 determines that the fastener driver 10 is due for maintenance.

The controller 200 may include a look-up table providing expected torque values of the motor 42 based on a number of operations performed by the fastener driver 10, a period of time since manufacturing of the fastener driver 10, or the like. The look-up table may indicate expected components that may require maintenance based on the torque values of the motor 42. For example, the torque value of the motor 42 may indicate that the bumper 98 requires maintenance or replacement, that the lifter 66 or lifter assembly 88 requires maintenance or replacement, that the mechanism 285 requires maintenance or replacement, or the like. In some instances, the torque value of the motor 42 indicates that the motor 42 requires maintenance or replacement. In some instances, the torque value of the motor 42 indicates that the cylinder 18 may need to be re-filled or otherwise requires maintenance. In a further instance, the controller 200 determines the cylinder 18 needs to be re-filled due to both a temperature of the cylinder 18 being below a temperature threshold (as indicated by temperature sensor 278) and the torque of the motor 42 being less than or equal to a torque threshold.

At block 2035, the controller 200 provides an indication of the condition of the fastener driver 10. For example, the controller 200 controls one or more of the indicator(s) 245 to provide an indication of the condition of the fastener driver 10. In an implementation where the indicators(s) 245 include LEDs, one LED may be controlled by the controller 200 to emit light to indicate that the fastener driver 10 requires maintenance. In another implementation, where the indicator(s) 245 include a display, the controller 200 may control the display to provide specific details regarding the condition of the fastener driver 10, such as which component requires maintenance. In some instances, the indication of the condition of the fastener driver 10 indicates that the fastener driver was not serviced as recommended and is being operated beyond a recommended maintenance time. In yet another instance, the indicator(s) 245 may include a re-pressurization LED to indicate that the pressure in the chamber 18 is low.

In some examples, the condition of the fastener driver 10 is a jamming of the fastener driver 10. For example, the controller 200 may detect a spike in the torque of the motor 42 (e.g., a torque increase from 40 Newton meters [“Nm” ] to 200 Nm within a 2-3 millisecond period during reload). In response to detecting the spike in the torque of the motor 42, the controller 200 determines the motor 42 is jammed and stops driving the motor 42.

In some instances, the controller 200 alters the firing procedure of the fastener driver 10 based on the torque of the motor 42. For example, during operation, the fastener driver 10 transitions from the ready-to-fire position, to the striker drop position, to the striker re-mesh position, and back to the ready-to-fire position, as previously described with respect to FIG. 3. The time from a user pulling the trigger to a fastener (e.g., a nail) being seated into a work surface is referred to as the time to fire. Examples described herein provide, among other things, an altering of the time to fire based on the estimated torque of the motor 42.

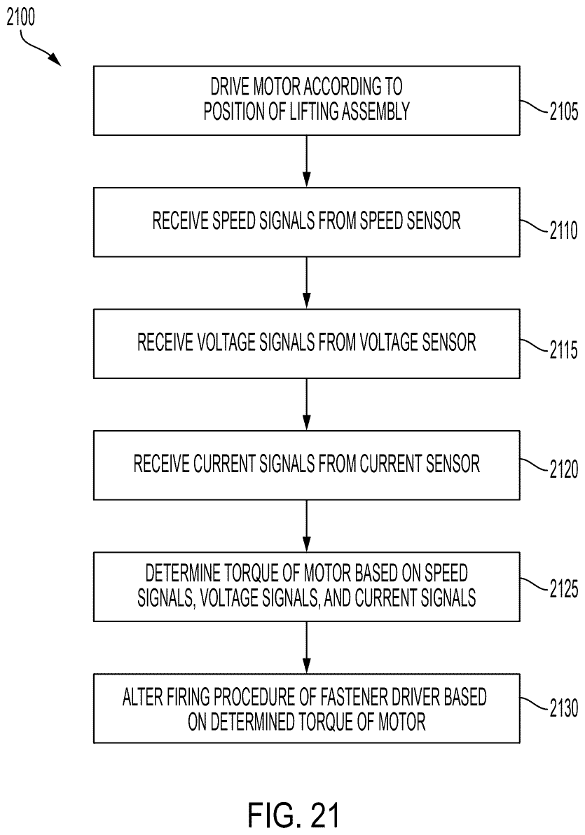

FIG. 21 provides a method 2100 for controlling the motor 42. The method 2000 may be performed by the controller 200. At block 2105, the controller 200 drives the motor 42 according to the position of the lifting assembly 88. For example, the controller 200 drives the motor 42 according to the high speed mode while the trigger 58 is actuated and based on the position of the lifter assembly 88.

At block 2110, the controller 200 receives speed signals from the speed sensor 250 indicative of the speed of the motor 42. At block 2115, the controller 200 receives voltage signals from the voltage sensor 272 indicative of a voltage of the battery pack 54. At block 2120, the controller 200 receives current signals from the current sensor 270 indicative of a current of the motor 42.

At block 2125, the controller 200 determines a torque of the motor 42 based on the speed signals, the voltage signals, and the current signals. In one example, the controller 200 compares the speed of the motor 42, the voltage of the battery pack 54, and the current of the motor 42 to a look-up table (e.g., a speed-voltage-current-torque look-up table) to estimate the torque of the motor 42. In another example, the controller 200 provides the speed of the motor 42, the voltage of the battery pack 54, and the current of the motor 42 as inputs to an algorithm that estimates the torque of the motor 42. In one embodiment, the algorithm is a machine-learning model trained to estimate the torque of the motor 42, as previously described with respect to block 825 of FIG. 8. The machine learning model may be stored in the memory 225.

At block 2130, the controller 200 alters the firing procedure of the fastener driver 10 based on the determined torque of the motor 42. For example, the fastener driver 10 starts from the ready-to-fire position (e.g., a reloaded state). The ready-to-fire position may define how much the lifter 66 would rotate before the mechanism 285 (e.g., the striker) is released. Due to increased loading, components like the rollers 90 endure increased stress, particularly when the mechanism 285 is closer to the striker drop position (e.g., a kickout position). Accordingly, in some instances, the mechanism 285 is controlled to intentionally stop further from kickout to reduce stress on these components. When the controller 200 estimates the torque of the motor 42, the controller 200 may control the motor 42 to stop the mechanism 285 closer to the true kickout position, providing the user with faster time to fire.

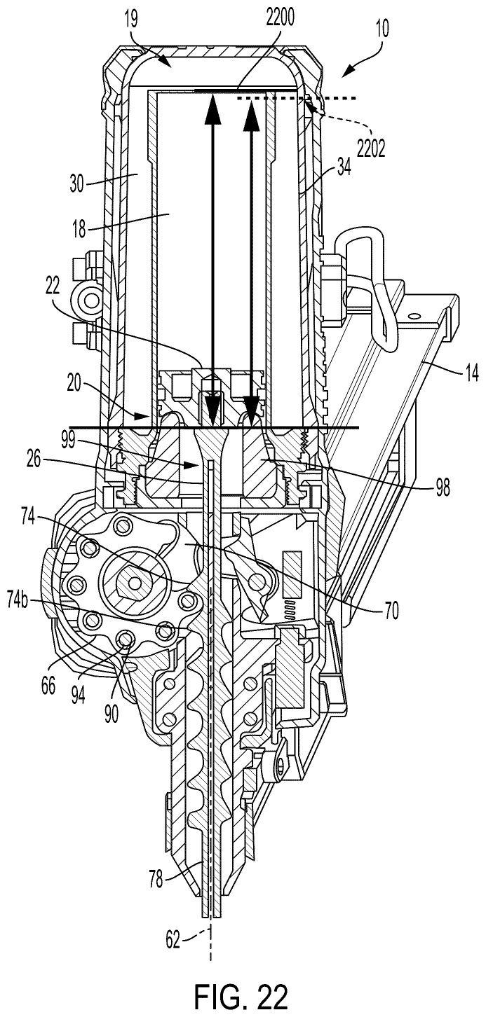

As fastener driver 10 ages, components may become slower due to wear and increased friction. The location of the striker drop position may be altered (e.g., reduced) to increase the time to fire and reduce stress applied to components of the fastener driver 10 (for example, the rollers 90). FIG. 22 provides one example of an altered striker drop position. The fastener driver 10 may have an initial striker drop position 2200. Once the torque of the motor 42 is greater than or equal to a threshold, the controller 200 adjusts the striker drop position to an altered striker drop position 2202 (for example, by controlling the motor 42 until the driver blade 26 is in the altered striker drop position 2202).

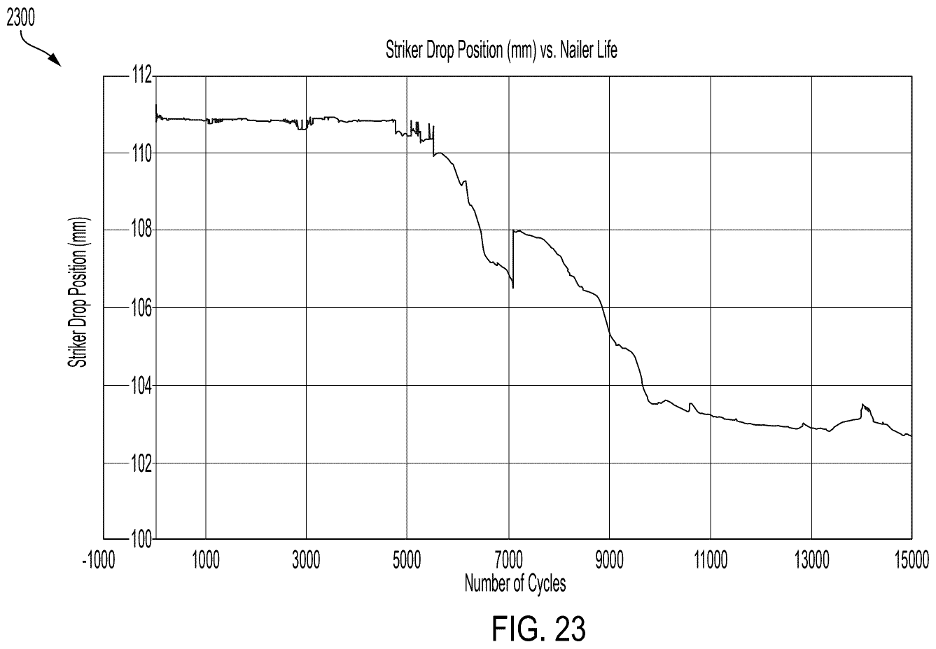

FIG. 23 provides a graph 2300 illustrating the change in the striker drop position compared to an increasing number of operating cycles of the fastener driver 10. As can be seen by the graph 2300, the striker drop position decreases over the lifespan of the fastener driver 10. For example, the striker drop position decreases from approximately 111 mm to approximately 103 mm.

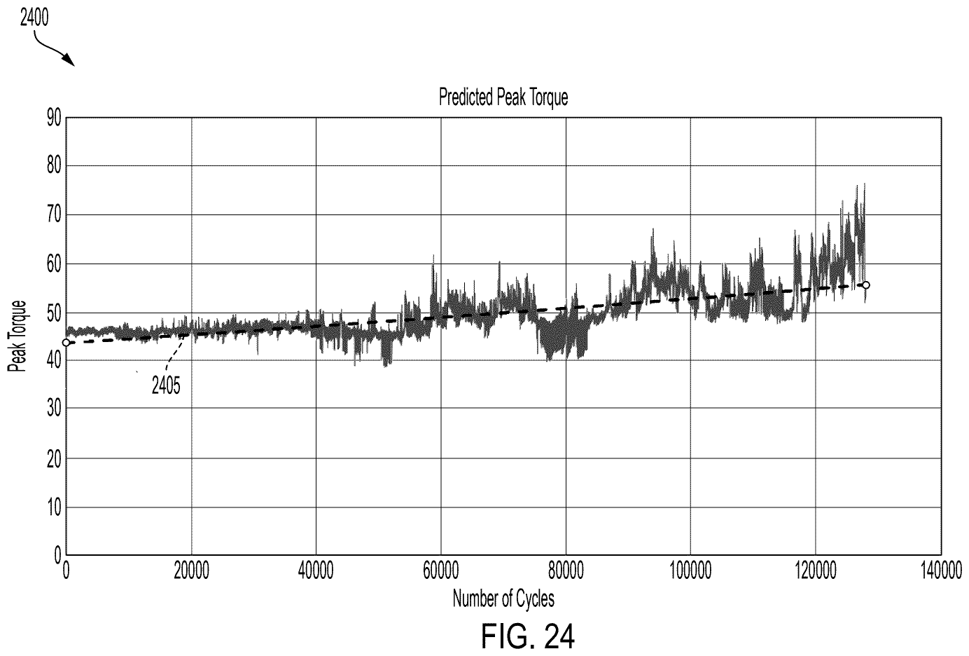

Additionally, FIG. 24 provides a graph 2400 illustrating an example of the predicted peak torque compared to an increasing number of operating cycles of the fastener driver 10. As can be seen by fitted line 2405, the predicted peak torque increases substantially linearly with the number of operating cycles. The torque of the motor 42 increases over the life span of the fastener driver 10.

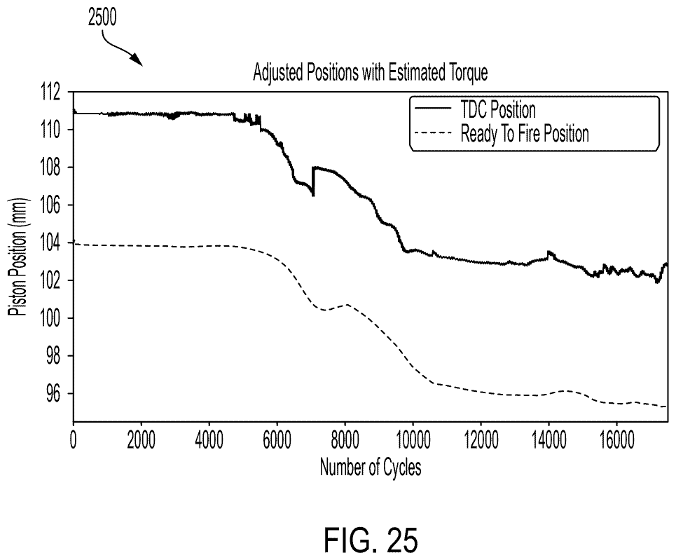

Accordingly, the torque of the motor 42 may be used by the controller 200 to alter the ready-to-fire position of the fastener driver 10 to account for the changes in the striker drop position. By way of example, assume the required torque for the ready-to-fire position is 20 Nm. As the tool ages and components experience wear, the kickout occurs earlier and the 20 Nm torque value is reached at an earlier time. Accordingly, the ready-to-fire position may be adjusted based on the actual increase in the torque of the motor 42 according to the graph 2400. FIG. 25 provides a graph 2500 illustrating an example of the ready-to-fire position and the TDC position being adjusted based on the estimated torque of the motor 42. Specifically, graph 2500 illustrates how the position of the piston 22 changes within the cylinder 18 based on the estimated torque of the motor 42 over the lifespan of the fastener driver 10. In both the ready-to-fire position and the TDC position, the position of the piston 22 is controlled by the controller 200 to decrease over the lifespan of the fastener driver 10.

In further examples of altering the firing procedure of the fastener driver 10 based on the determined torque of the motor 42, the controller 200 may reduce the field weakening angle (e.g., phase advance angle, conduction angle, or both) implemented by the field weakening module 322, may limit a maximum value of the speed command provided by the speed controller 312, may limit a fire rate of the fastener driver 10, or the like.

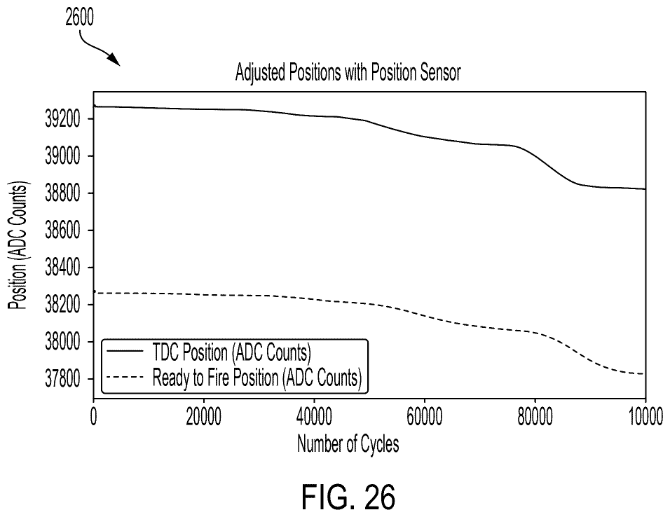

In some instances, the controller 200 adjusts the ready-to-fire position based on a signal from the position sensor 276 indicating a position of the lifter assembly 88. As the striker drop position changes over time, the signal provided by the position sensor 276 indicative of the position of the lifter assembly 88 also changes. The ready-to-fire position may be adjusted by the controller 200 based on the position of the lifter assembly 88. FIG. 26 provides a graph 2600 illustrating an example of the ready-to-fire position and the TDC position being adjusted based on signals provided by the position sensor 276. As the TDC position changes over time, the controller 200 adjusts the ready-to-fire position.

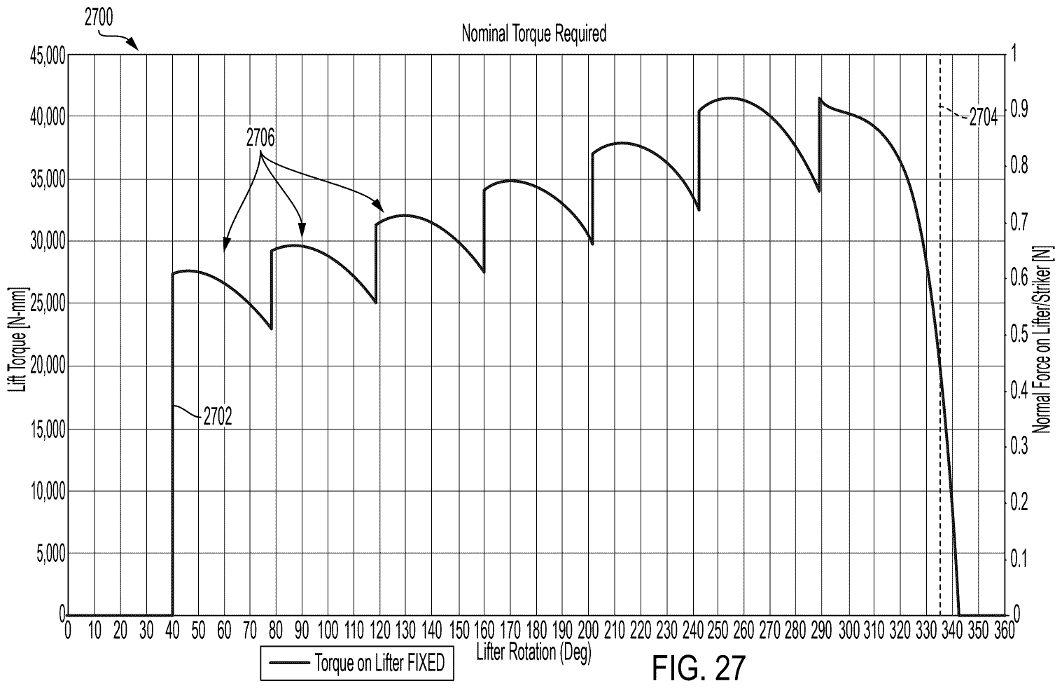

FIG. 27 provides a graph 2700 illustrating one rotational cycle of the lifter 66. Specifically, the graph 2700 illustrates the relationship between the lift torque and the lifter rotation (in degrees), shown by a function 2702. By monitoring the torque, the controller 200 may identify when kickout happens (e.g., the torque goes to zero as indicated by threshold 2704). Additionally, the controller 200 may identify when each lifter pin (e.g., lift teeth 74, 75) is engaged with the mechanism 285 by decreases in torque (at positions 2706).

Examples described herein may also be implemented for power tools other than the fastener driver 10. By way of one example, by estimating the torque in a circle saw or a chainsaw, the controller 200 may control the motor 42 to stop in the event of detecting a mechanical bind-up or kickback event based on the estimated torque of the motor 42. In another example, the controller 200 may control the motor 42 to stop a drywall screw gun based on the estimated torque indicating that a screw is seated into a workpiece.

Thus, embodiments provided herein describe, among other things, systems and methods for estimating a torque of a power tool and controlling the power tool based on the estimated torque. Various features and advantages are set forth in the following claims.

What is claimed is:

1. A fastener driver comprising:
a motor;
a trigger;
a battery pack interface configured to receive a battery pack;
a lifting assembly operable to be moved by the motor;
a speed sensor configured to sense a speed of the motor;
a voltage sensor configured to sense a voltage of the battery pack;
a current sensor configured to sense a current of the motor; and
a controller connected to the trigger, the motor, the speed sensor, the voltage sensor, and the current sensor, the controller configured to:
provide, in response to actuation of the trigger and based on a position of the lifting assembly, power to the motor,
receive speed signals from the speed sensor indicative of the speed of the motor,
receive voltage signals from the voltage sensor indicative of the voltage of the battery pack,
receive current signals from the current sensor indicative of the current of the motor,
determine a torque of the motor based on the speed signals, the voltage signals, and the current signals,
determine a condition of the fastener driver based on the torque of the motor, and
provide an indication of the condition of the fastener driver.

2. The fastener driver of claim 1, wherein the condition of the fastener driver includes a condition of the lifting assembly.

3. The fastener driver of claim 1, further comprising:
a pressurized cylinder; and
a bumper located at a bottom end of the cylinder,
wherein the condition of the fastener driver includes a condition of the bumper.

4. The fastener driver of claim 1, further comprising:
a pressurized cylinder,
wherein the condition of the fastener driver includes a determination that a pressure of the cylinder is below a pressure threshold.

5. The fastener driver of claim 1, wherein the condition of the fastener driver includes a jamming of the motor.

6. A method for determining a condition of a fastener driver, the method comprising:
providing, in response to actuation of a trigger and based on a position of a lifting assembly, power to a motor;
receiving speed signals from a speed sensor indicative of a speed of the motor;
receiving voltage signals from a voltage sensor indicative of a voltage of a battery pack;
receiving current signals from a current sensor indicative of a current of the motor;
determining a torque of the motor based on the speed signals, the voltage signals, and the current signals;
determining a condition of the fastener driver based on the torque of the motor, and
providing an indication of the condition of the fastener driver.

7. The method of claim 6, wherein the condition of the fastener driver includes a condition of the lifting assembly.

8. The method of claim 6, wherein the condition of the fastener driver includes a condition of a bumper located at a bottom end of a cylinder.

9. The method of claim 6, wherein determining the condition of the fastener driver includes determining that a pressure of a cylinder is below a pressure threshold.

10. The method of claim 6, wherein the condition of the fastener driver includes a jamming of the motor.

11. A fastener driver comprising:
a motor;
a trigger;
a battery pack interface configured to receive a battery pack;
a lifting assembly operable to be moved by the motor;
a speed sensor configured to sense a speed of the motor;
a voltage sensor configured to sense a voltage of the battery pack;
a current sensor configured to sense a current of the motor; and
a controller connected to the trigger, the motor, the speed sensor, the voltage sensor, and the current sensor, the controller configured to:
provide, in response to actuation of the trigger and based on a position of the lifting assembly, power to the motor,
receive speed signals from the speed sensor indicative of the speed of the motor,
receive voltage signals from the voltage sensor indicative of the voltage of the battery pack,
receive current signals from the current sensor indicative of the current of the motor,
determine a torque of the motor based on the speed signals, the voltage signals, and the current signals, and
alter a firing procedure of the fastener driver based on the torque of the motor.

12. The fastener driver of claim 11, wherein, to alter the firing procedure of the fastener driver, the controller is configured to:
adjust a ready-to-fire position of the lifting assembly based on the torque of the motor.

13. The fastener driver of claim 11, wherein, to alter the firing procedure of the fastener driver, the controller is configured to:
reduce a field weaking angle implemented by a field weakening module based on the torque of the motor.

14. The fastener driver of claim 11, wherein, to alter the firing procedure of the fastener driver, the controller is configured to:
limit a maximum value of a speed command used to drive the motor based on the torque of the motor.

15. The fastener driver of claim 11, wherein the controller is further configured to:
drive, after altering the firing procedure of the fastener driver and in response to actuation of the trigger, the motor based on the altered firing procedure.

16. A method of operating a fastener driver, the method comprising:
providing, in response to actuation of a trigger and based on a position of a lifting assembly, power to a motor;
receiving speed signals from a speed sensor indicative of a speed of the motor;
receiving voltage signals from a voltage sensor indicative of a voltage of a battery pack;
receiving current signals from a current sensor indicative of a current of the motor;
determining a torque of the motor based on the speed signals, the voltage signals, and the current signals; and
altering a firing procedure of the fastener driver based on the torque of the motor.

17. The method of claim 16, wherein altering the firing procedure of the fastener driver based on the torque of the motor includes adjusting a ready-to-fire position of the lifting assembly based on the torque of the motor.

18. The method of claim 16, wherein altering the firing procedure of the fastener driver based on the torque of the motor includes reducing a field weakening angle implemented by a field weakening module based on the torque of the motor.

19. The method of claim 16, wherein altering the firing procedure of the fastener driver based on the torque of the motor includes limiting a maximum value of a speed command used to drive the motor based on the torque of the motor.

20. The method of claim 16, further comprising:
driving, after altering the firing procedure of the fastener driver and in response to actuation of the trigger, the motor based on the altered firing procedure.
